(19) United States
(12) Patent Application Publication
(10) Pub. No.: US 2021/0292026 A1
(43) Pub. Date: Sep. 23, 2021

(54) BAG-MAKING AND PACKAGING APPARATUS

(71) Applicant: ISHIDA CO., LTD., Kyoto-shi (JP)

(72) Inventors: Makoto ICHIKAWA, Ritto-shi (JP); Toru MORIHIRA, Ritto-shi (JP); Tatsuo ITO, Ritto-shi (JP); Ryoichi SATO, Ritto-shi (JP); Kazuaki TAKAMORI, Ritto-shi (JP)

(21) Appl. No.: 17/209,225

(22) Filed: Mar. 23, 2021

(30) Foreign Application Priority Data
Mar. 23, 2020 (JP) 2020-051673
Mar. 23, 2020 (JP) 2020-051674

(51) Int. Cl. B65B 61/02; B65B 57/04; B65B 9/093; B41M 5/00

(52) U.S. Cl. CPC B65B 61/025; B41M 5/0041; B65B 9/093; B65B 57/04

(57) ABSTRACT

A bag-making and packaging apparatus, for forming a bag containing a packaged article from a conveyed packaging material, is disclosed. The apparatus includes a printing part, first and second receiving parts, and a retaining part. The printing part prints information on the packaging material. The first receiving part is used in a first mode to print on the packaging material during conveyance without stopping conveyance. The second receiving part is used in a second mode to print on the packaging material at a timing when conveyance of the packaging material is stopped. The retaining part retains the first receiving part or the second receiving part so that the first receiving part and the printing part face each other with the packaging material disposed therebetween in the first mode, and the second receiving part and the printing part face each other with the packaging material disposed therebetween in the second mode.

### CROSS-REFERENCE TO RELATED APPLICATIONS

This application claims priority to Japanese Applications No. 2020-051673, filed on Mar. 23, 2020, and No. 2020-051674, filed on Mar. 23, 2020. The contents of those applications are incorporated by reference herein in their entireties.

### TECHNICAL FIELD

The present invention relates to a bag-making and packaging apparatus.

### BACKGROUND ART

A bag-making and packaging apparatus to manufacture a bag in which an article is packaged by transversely sealing a cylindrically shaped packaging material, as disclosed in Japanese Patent Unexamined Publication JP 2012-136270 A, is conventionally known. The bag-making and packaging apparatus is provided with a printing device to print pre-set information on the packaging material prior to shaping thereof into a cylindrical shape, and a platen which is arranged so as to face a print head of the printing device.

Bag-making and packaging apparatuses are classified mainly as continuous-type packaging machines in which transverse sealing is performed while the packaging material is continuously conveyed, and intermittent-type packaging machines in which transverse sealing is performed while the packaging material is intermittently conveyed. The printing device of a continuous-type packaging machine prints on the packaging material during conveyance thereof, without stopping conveyance of the packaging material. The printing device of an intermittent-type packaging machine prints on the packaging material while the packaging material is stopped, at a timing at which conveyance of the packaging material is stopped.

A continuous-type packaging machine is a superior model, obtained by making an intermittent-type packaging machine capable of continuous conveyance of the packaging material. Specifically, a transverse sealing mechanism of the continuous-type packaging machine is backwards-compatible with the transverse sealing mechanism of the intermittent-type packaging machine. Therefore, using a single transverse sealing mechanism, a bag-making and packaging apparatus can be configured so as to be capable of switching between a continuous mode for performing transverse sealing while continuously conveying the packaging material, and an intermittent mode for performing transverse sealing while intermittently conveying the packaging material.

### BRIEF SUMMARY

However, despite the fact that the same printing device can be used in the continuous-type packaging machine and the intermittent-type packaging machine, the platen used in the continuous-type packaging machine and the platen used in the intermittent-type packaging machine have mutually different shapes. For this reason, in a bag-making and packaging apparatus that is capable of switching between a continuous mode and an intermittent mode, it is necessary to mount both a set of the platen and printing device used in the continuous-type packaging machine, and a set of the platen and printing device used in the intermittent-type packaging machine. In this case, costs are incurred from the need to secure space for installing two identical printing devices. There is therefore a need for a bag-making and packaging apparatus in which only one printing device is provided, and in which it is possible to easily switch between a platen that is used by a continuous-type packaging machine and a platen that is used by an intermittent-type packaging machine.

An object of the present invention is to provide a bag-making and packaging apparatus in which an operating mode can be switched, and a platen used in each operating mode can easily be switched.

A bag-making and packaging apparatus according to a first aspect of the present invention forms a bag in which an article is packaged from a packaging material, while conveying the packaging material. The bag-making and packaging apparatus comprises a printing part, a first receiving part, a second receiving part, and a retaining part. The printing part prints predetermined information on the packaging material before the bag is formed. The first receiving part is used in a first printing mode to print on the packaging material during conveyance thereof, without stopping conveyance of the packaging material. The second receiving part is used in a second printing mode to print on the stopped packaging material at a timing at which conveyance of the packaging material is stopped. The retaining part retains at least one of the first receiving part and the second receiving part. The retaining part retains at least one of the first receiving part and the second receiving part so that the first receiving part and the printing part face each other with the packaging material disposed therebetween in the first printing mode, and the second receiving part and the printing part face each other with the packaging material disposed therebetween in the second printing mode.

In the bag-making and packaging apparatus of the present invention, printing on the packaging material is performed using the first receiving part when in the continuous mode in which a bag is continuously formed while the packaging material is continuously conveyed, and printing on the packaging material is performed using the second receiving part when in the intermittent mode in which a bag is formed while the packaging material is intermittently conveyed. In the bag-making and packaging apparatus of the present invention, the receiving part used during printing on the packaging material can easily be switched in accordance with the operating mode.

A bag-making and packaging apparatus according to a second aspect of the present invention forms a bag in which an article is packaged from a packaging material, while conveying the packaging material. The bag-making and packaging apparatus comprises a printing part, a first receiving part, a second receiving part, and a switching part. The printing part prints predetermined information on the packaging material before the bag is formed. The first receiving part is used for printing on the packaging material during conveyance thereof, without stopping conveyance of the packaging material. The second receiving part is used for printing on the stopped packaging material at a timing at which conveyance of the packaging material is stopped. The switching part switches between a first printing state in which the first receiving part and the printing part face each other with the packaging material disposed therebetween, and a second printing state in which the second receiving part and the printing part face each other with the packaging material disposed therebetween.

In the bag-making and packaging apparatus of the present invention, printing on the packaging material is performed using the first receiving part when in the continuous mode in which a bag is continuously formed while the packaging material is continuously conveyed, and printing on the packaging material is performed using the second receiving part when in the intermittent mode in which a bag is formed while the packaging material is intermittently conveyed. In the bag-making and packaging apparatus of the present invention, the receiving part used during printing on the packaging material can easily be switched in accordance with the operating mode.

A bag-making and packaging apparatus according to a third aspect of the present invention is the bag-making and packaging apparatus according to the second aspect, wherein the switching part switches between the first printing state and the second printing state by causing at least one of the first receiving part and the second receiving part to move.

A bag-making and packaging apparatus according to a fourth aspect of the present invention is the bag-making and packaging apparatus according to the second aspect, wherein the switching part switches between the first printing state and the second printing state by causing the printing part to move.

A bag-making and packaging apparatus according to a fifth aspect of the present invention is the bag-making and packaging apparatus according to the fourth aspect, wherein the switching part causes the printing part to move along the packaging material.

A bag-making and packaging apparatus according to a sixth aspect of the present invention is the bag-making and packaging apparatus according to any one of the second through fifth aspects, further comprising a conveyance roller for sending the packaging material between the first receiving part and the printing part, or between the second receiving part and the printing part. The switching part switches between the first printing state and the second printing state by causing the conveyance roller to move.

A bag-making and packaging apparatus according to a seventh aspect of the present invention is the bag-making and packaging apparatus according to any one of the first through fifth aspects, wherein the first receiving part is a cylindrical member, and the second receiving part is a flat-plate-shaped member.

A bag-making and packaging apparatus according to an eighth aspect of the present invention is the bag-making and packaging apparatus according to the first or second aspect, further comprising a control unit. The control unit controls operation of the printing part on the basis of predetermined information inputted in advance. The printing part has the first printing mode and the second printing mode as selectable printing modes for printing on the packaging material. The control unit switches the printing mode to the first printing mode when it is determined that the timing of printing on the packaging material is during conveyance of the packaging material, on the basis of the predetermined information. The control unit switches the printing mode to the second printing mode when it is determined that the timing of printing on the packaging material is during stoppage of the packaging material, on the basis of the predetermined information.

In this bag-making and packaging apparatus, because the printing mode is decided according to the timing of printing on the packaging material regardless of whether bags are manufactured continuously or intermittently, there is no need for the operator to be conscious of which printing mode to operate in, and the printing mode that is suited for production is selected, thereby preventing misoperation.

A bag-making and packaging apparatus according to a ninth aspect of the present invention is the bag-making and packaging apparatus according to the first or second aspect, further comprising a control unit and an instruction unit. The control unit controls operation of the printing part. The printing part has the first printing mode and the second printing mode as a plurality of selectable printing modes for printing on the packaging material. The instruction unit instructs the control unit to switch the printing mode. The control unit switches the printing mode to the first printing mode when it is determined that the timing of printing on the packaging material is during conveyance of the packaging material, on the basis of predetermined information inputted in advance and an instruction from the instruction unit. The control unit switches the printing mode to the second printing mode when it is determined that the timing of printing on the packaging material is during stoppage of the packaging material, on the basis of predetermined information inputted in advance and an instruction from the instruction unit.

A bag-making and packaging apparatus according to a tenth aspect of the present invention is the bag-making and packaging apparatus according to the eighth or ninth aspect, wherein the control unit has, as selectable conveyance modes for conveying the packaging material, a first conveyance mode and a second conveyance mode. The first conveyance mode is a mode to continuously convey the packaging material. The second conveyance mode is a mode to intermittently convey the packaging material. The predetermined information includes a result of selecting the conveyance mode.

A bag-making and packaging apparatus according to an eleventh aspect of the present invention is the bag-making and packaging apparatus according to the tenth aspect, wherein the control unit switches the printing mode to the first printing mode when the conveyance mode is the second conveyance mode and it is determined that the timing of printing on the packaging material is during conveyance of the packaging material.

In this bag-making and packaging apparatus, the printing mode is switched according to whether the printing timing is during conveyance or during stopping of the packaging material, even in the second (intermittent) conveyance mode, rather than simply switching to the first printing mode when in the first conveyance mode (continuous), or switching to the second printing mode when in the second conveyance mode (intermittent). The printing mode that is suited for production is therefore selected.

In the bag-making and packaging apparatus of the present invention, the receiving part that is used during printing on the packaging material can easily be switched in accordance with the operating mode.

### BRIEF DESCRIPTION OF THE DRAWINGS

FIG. 1 is a perspective view of a bag-making and packaging apparatus according to a first embodiment.

FIG. 2 is a perspective view showing a simplified configuration of a bag-making and packaging unit.

FIG. 3 is a simplified side view, as seen from the right side of FIG. 2, of a transverse sealing mechanism.

FIG. 4 is a side view of a film supply unit in a continuous mode in the first embodiment.

FIG. 5 is a side view of the film supply unit in an intermittent mode in the first embodiment.

FIG. 6 is a side view of the film supply unit in a continuous mode in a second embodiment.

FIG. 7 is a side view of the film supply unit in an intermittent mode in the second embodiment.

FIG. 8 is a block diagram of a control unit in a third embodiment.

FIG. 9 is a flowchart of printing mode switching control performed before operation of the film supply unit in the third embodiment.

FIG. 10 is a simplified side view of the film supply unit when a printing device of the bag-making and packaging apparatus according to a fourth embodiment is operating in a first printing mode.

FIG. 11 is a simplified side view of the film supply unit when the printing device of the bag-making and packaging apparatus according to the fourth embodiment is operating in a second printing mode.

FIG. 12 is a simplified side view of the film supply unit when a printing device of the bag-making and packaging apparatus according to a fifth embodiment is operating in the first printing mode.

FIG. 13 is a simplified side view of the film supply unit when the printing device of the bag-making and packaging apparatus according to the fifth embodiment is operating in the second printing mode.

FIG. 14 is a simplified side view of the film supply unit when a printing device of the bag-making and packaging apparatus according to a sixth embodiment is operating in the first printing mode.

FIG. 15 is a simplified side view of the film supply unit when the printing device of the bag-making and packaging apparatus according to the sixth embodiment is operating in the second printing mode.

FIG. 16 is a simplified side view of the film supply unit when a printing device of the bag-making and packaging apparatus according to a seventh embodiment is operating in the first printing mode.

FIG. 17 is a simplified side view of the film supply unit when the printing device of the bag-making and packaging apparatus according to the seventh embodiment is operating in the second printing mode.

FIG. 18 is a side view of the film supply unit in the continuous mode in Modification A.

FIG. 19 is a side view of the film supply unit in the intermittent mode in Modification A.

FIG. 20 is a side view of the film supply unit in the continuous mode in Modification B.

FIG. 21 is a side view of the film supply unit in the intermittent mode in Modification B.

### DETAILED DESCRIPTION

The embodiment of the present invention will be described while referring to the drawings. The embodiment described below is one specific example of the present invention, and is not intended to limit the technical scope of the present invention.

### First Embodiment

### (1) Configuration of Bag-Making and Packaging Apparatus

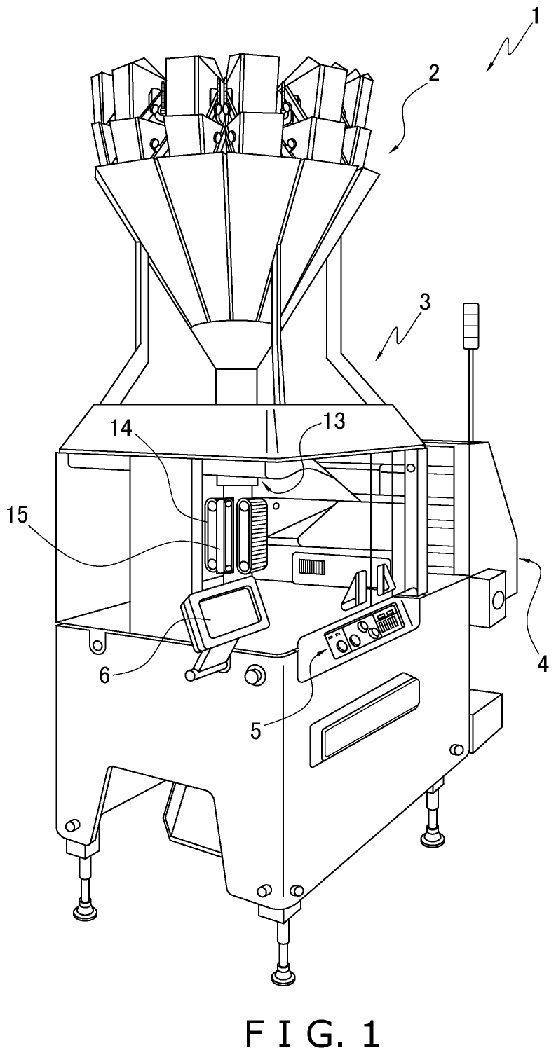

FIG. 1 is a perspective view of a bag-making and packaging apparatus 1 according to a first embodiment of the present invention. The bag-making and packaging apparatus 1 is a machine for bagging a food product or other package contents. The bag-making and packaging apparatus 1 is configured mainly from a combination weighing unit 2, a bag-making and packaging unit 3, and film supply unit 4.

The combination weighing unit 2 is arranged above the bag-making and packaging unit 3. The combination weighing unit 2 weighs out the weight of package contents with a plurality of weighing hoppers, and combines the weights measured in each of the weighing hoppers, to arrive at a prescribed total weight. The combination weighing unit 2 then downwardly discharges the package contents, in the prescribed combined total weight, to supply the package contents to the bag-making and packaging unit 3.

The bag-making and packaging unit 3 seals package contents into a bag to form a package in accordance with the timing at which the package contents are supplied from the combination weighing unit 2. The detailed configuration and action of the bag-making and packaging unit 3 will be discussed below.

The film supply unit 4 is arranged adjacent to the bag-making and packaging unit 3, and supplies a film to be shaped into a bag to the bag-making and packaging unit 3. A film roll onto which the film is wound is installed in the film supply unit 4. The film supply unit 4 reels out the film from a film roll. The detailed configuration and action of the film supply unit 4 will be discussed below.

The bag-making and packaging apparatus 1 is provided with an operation switch 5 and a liquid crystal display 6. The operation switch 5 and the liquid crystal display 6 are mounted to the front surface of the body of the bag-making and packaging apparatus 1. The liquid crystal display 6 is a touch panel display arranged at a location visible to the operator of the operation switch 5. The operation switch 5 and the liquid crystal display 6 function as input devices for receiving instructions for the bag-making and packaging apparatus 1, and settings relating to the bag-making and packaging apparatus 1. The liquid crystal display 6 also functions as an output device for displaying information relating to the bag-making and packaging apparatus 1.

The bag-making and packaging apparatus 1 is provided with a control unit (not illustrated). The control unit is a computer configured from a CPU, ROM, RAM, and the like. The control unit is connected to the combination weighing unit 2, the bag-making and packaging unit 3, the film supply unit 4, the operation switch 5, and the liquid crystal display 6. On the basis of input from the operation switch 5 and the liquid crystal display 6, the control unit controls the combination weighing unit 2, the bag-making and packaging unit 3, and the film supply unit 4, and outputs information of various kinds to the liquid crystal display 6.

### (2) Configuration of Bag-Making and Packaging Unit

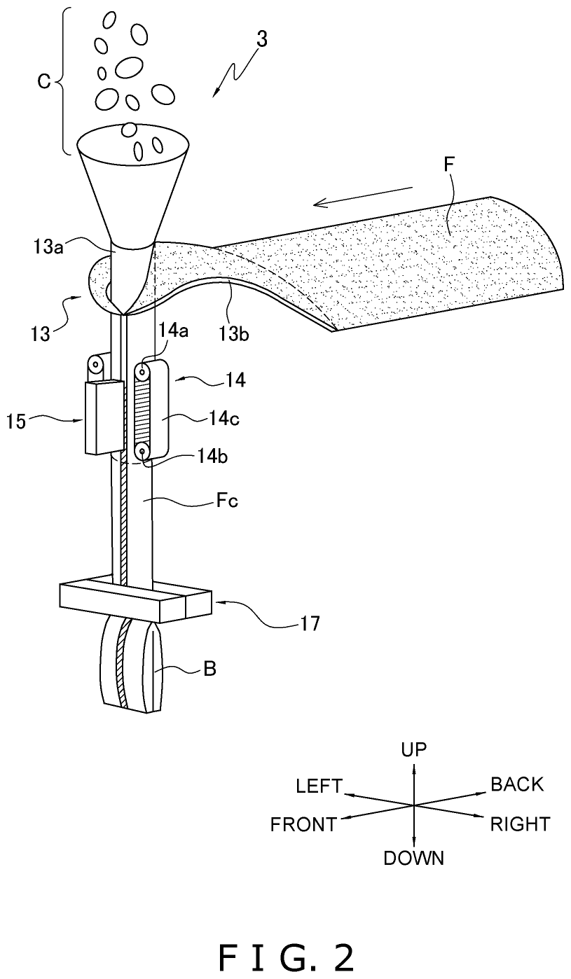

FIG. 2 is a perspective view showing a simplified configuration of the bag-making and packaging unit 3. In the description below, the six directions “front (front surface),” “back (back surface),” “up,” “down,” “left,” and “right” are defined as shown in FIG. 2.

The bag-making and packaging unit 3 is configured mainly from a shaping mechanism 13, a pull-down belt mechanism 14, a longitudinal sealing mechanism 15, and a transverse sealing mechanism 17. The shaping mechanism 13 shapes a sheet-shaped film F, which is supplied from the film supply unit 4, into a tube shape. The pull-down belt mechanism 14 conveys the cylindrically shaped film F downward. The longitudinal sealing mechanism 15 seals, in a longitudinal direction parallel to the conveying direction, portions where both edges of the cylindrically shaped film F overlap, and forms a cylindrical film Fc. The transverse sealing mechanism 17 seals the cylindrical film Fc in a transverse direction orthogonal to the conveying direction, forming bags B which are sealed at their top edge portion and bottom edge portion.

The bag-making and packaging apparatus 1 has two operating modes, consisting of a continuous mode in which bags B are formed while the film F is continuously conveyed, and an intermittent mode in which bags B are formed while the film F is intermittently conveyed. The continuous mode is an operating mode in which bags B are formed without stopping conveyance of the film F. The intermittent mode is an operating mode in which bags B are formed while conveyance of the film F is temporarily stopped at a predetermined timing.

In the continuous mode, the bag-making and packaging unit 3 seals the film F as the film F is being conveyed. In the intermittent mode, the bag-making and packaging unit 3 seals stopped film F at the timing at which conveyance of the film F is stopped. The control unit of the bag-making and packaging apparatus 1 controls the bag-making and packaging unit 3 in accordance with the operating mode.

### (2-1) Shaping Mechanism

The shaping mechanism 13 has a tube 13a and a former 13b. The tube 13a is a round cylindrical member open at the top end and the bottom end. Package contents C supplied from the combination weighing unit 2 are charged into the opening at the top end of the tube 13a. The former 13b is arranged so as to encircle the tube 13a. As the film F reeled out from the film roll of the film supply unit 4 passes through a gap between the tube 13a and the former 13b, the film wraps about the tube 13a to form a tube shape. The tube 13a and the former 13b can be swapped out according to the size of the bags B being manufactured.

### (2-2) Pull-Down Belt Mechanism

The pull-down belt mechanism 14 conveys downward the film F, which has wrapped about the tube 13a, while holding the film under suction. The pull-down belt mechanism 14 has mainly a drive roller 14a, a driven roller 14b, and a pair of belts 14c. The pair of belts 14c are arranged so as to sandwich the tube 13a on the left and right sides of the tube 13a as shown in FIG. 2, and have a mechanism for holding the cylindrically shaped film F under suction. The pull-down belt mechanism 14 conveys the cylindrically shaped film F downward, due to the pair of belts 14c being rotatably driven by the drive roller 14a and the driven roller 14b.

### (2-3) Longitudinal Sealing Mechanism

The longitudinal sealing mechanism 15 seals the cylindrically shaped film F in the longitudinal direction (the vertical direction in FIG. 2). The longitudinal sealing mechanism 15 is arranged on the front surface side of the tube 13a. A drive mechanism (not illustrated) moves the longitudinal sealing mechanism 15 in the forward-backward direction so as to approach or move away from the tube 13a.

By driving the longitudinal sealing mechanism 15 closer to the tube 13a using the drive mechanism, longitudinal-direction overlapping portions of the film F wrapped about the tube 13a are sandwiched between the longitudinal sealing mechanism 15 and the tube 13a. The overlapping portions of the film F are heated while being pressed against the tube 13a under fixed pressure by the drive mechanism, heat-sealing the overlapping portions of the film F in the longitudinal-direction and forming a cylindrical film Fc. The longitudinal sealing mechanism 15 has a heater for heating the overlapping portions of the film F, a heater belt that contacts the overlapping portions of the film F, and the like.

### (2-4) Transverse Sealing Mechanism

The transverse sealing mechanism 17 seals the cylindrical film Fc in the transverse direction (the left-right direction in FIG. 2). The transverse sealing mechanism 17 is arranged below the shaping mechanism 13, the pull-down belt mechanism 14, and the longitudinal sealing mechanism 15.

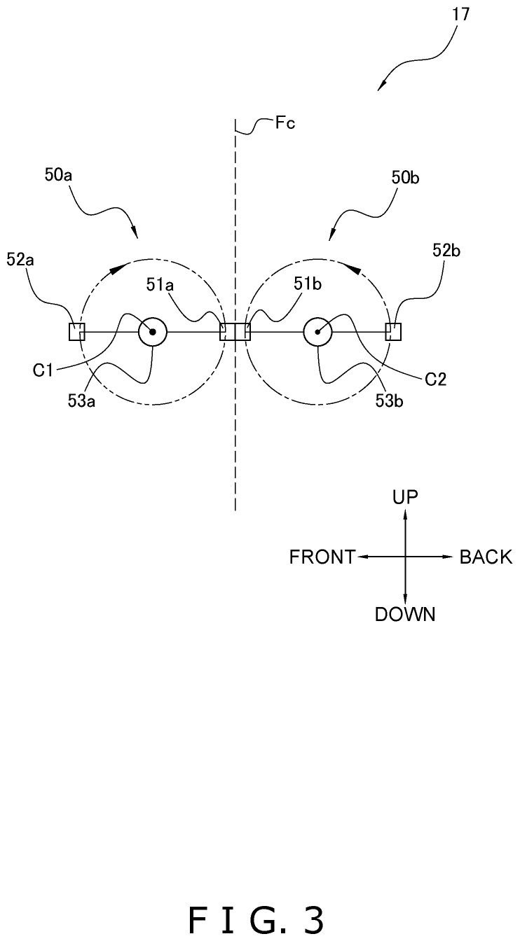

FIG. 3 is a simplified side view of the transverse sealing mechanism 17 as seen from the right side of FIG. 2. The direction perpendicular to the image plane in FIG. 3 is the left-right direction in FIG. 2. The transverse sealing mechanism 17 comprises mainly a first rotating body 50a and a second rotating body 50b. The first rotating body 50a is arranged on the front side of the cylindrical film Fc. The second rotating body 50b is arranged on the rear side of the cylindrical film Fc. In the plane of the drawing of FIG. 3, the first rotating body 50a is positioned on the left side of the cylindrical film Fc, and the second rotating body 50b is positioned on the right side of the cylindrical film Fc.

The first rotating body 50a comprises mainly a first rotating shaft 53a, a first sealing jaw 51a, and a second sealing jaw 52a. The second rotating body 50b comprises mainly a second rotating shaft 53b, a first sealing jaw 51b, and a second sealing jaw 52b. With the first rotating shaft 53a as a rotating shaft, the first rotating body 50a rotates about a rotational center C1 of the first rotating shaft 53a, as seen along the left-right direction. With the second rotating shaft 53b as a rotating shaft, the second rotating body 50b rotates about the rotational center C2 of the second rotating shaft 53b, as seen along the left-right direction. When the transverse sealing mechanism 17 is seen along the left-right direction, the pair of first sealing jaws 51a, 51b rotate synchronously in opposite directions from each other, and the pair of second sealing jaws 52a, 52b rotate synchronously in opposite directions from each other. In FIG. 3, the path of the pair of first sealing jaws 51a, 51b and the pair of second sealing jaws 52a, 52b is indicated by dashed lines.

In the transverse sealing mechanism 17, the cylindrical film Fc is sandwiched along the transverse direction (the left-right direction in FIG. 2) intersecting with the conveying direction of the cylindrical film Fc by the pair of first sealing jaws 51a, 51b or the pair of second sealing jaws 52a, 52b. The pair of first sealing jaws 51a, 51b or the pair of second sealing jaws 52a, 52b heat the cylindrical film Fc while sandwiching the cylindrical film Fc, and thereby heat-seal the cylindrical film Fc in the transverse direction.

### (3) Configuration of Film Supply Unit

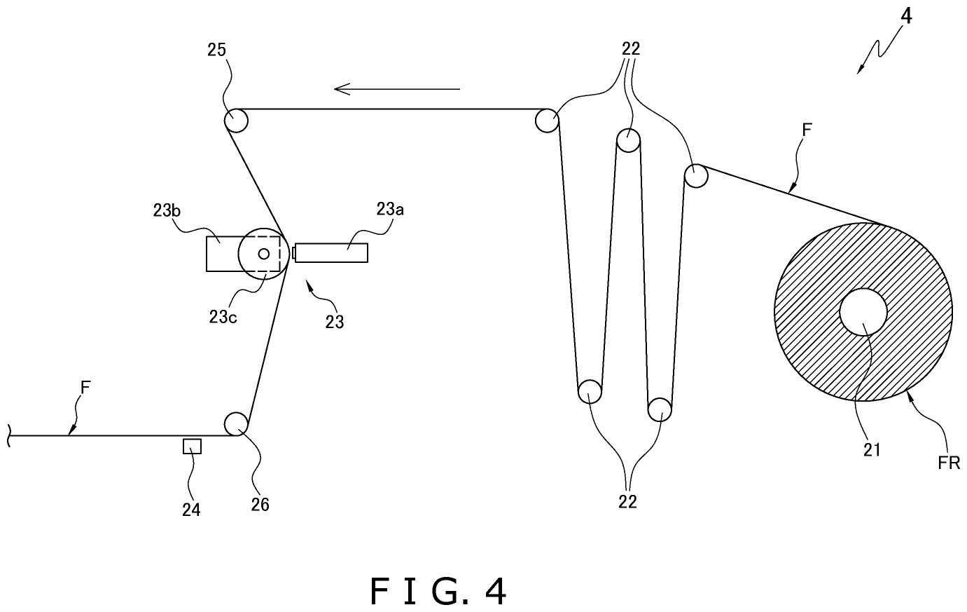

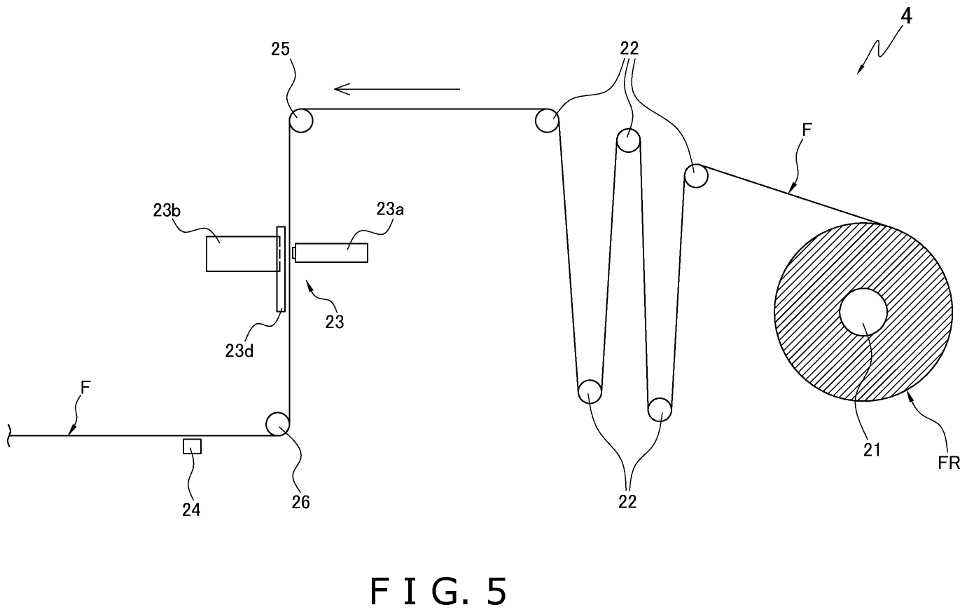

FIGS. 4 and 5 are side views showing a simplified configuration of the film supply unit 4 of the present embodiment. In the plane of the paper surface of FIGS. 4 and 5, the sheet-shaped film F is conveyed from right (upstream) to left (downstream). The conveying direction of the film F is indicated by arrows in FIGS. 4 and 5. FIG. 4 illustrates a configuration in the continuous mode. FIG. 5 illustrates a configuration in the intermittent mode. The film supply unit 4 reels out the film F from a film roll FR, prints predetermined information on the surface of the film F, and supplies the film F to the shaping mechanism 13 of the bag-making and packaging unit 3. The film supply unit 4 comprises mainly an air shaft 21, a plurality of tension rollers 22, a printing device 23, an inspection device 24, and feed rollers 25, 26.

In the continuous mode, the film supply unit 4 continuously reels out the film F from the film roll FR. In the intermittent mode, the film supply unit 4 intermittently reels out the film F from the film roll FR. The control unit of the bag-making and packaging apparatus 1 controls the film supply unit 4 in accordance with the operating mode.

### (3-1) Air Shaft

The air shaft 21 is a shaft on which the film roll FR is set, the sheet-shaped film F being wound onto the film roll FR. The film roll FR is secured by vacuum suction to the air shaft 21. The air shaft 21 is rotatably driven by a shaft drive motor (not illustrated). The shaft drive motor causes the air shaft 21 to rotate, and the sheet-shaped film F wound onto the film roll FR is thereby reeled out.

The film F reeled out from the film roll FR in the film supply unit 4 is ultimately sent to the bag-making and packaging unit 3. In the bag-making and packaging unit 3, the film F is shaped into a tube shape by the shaping mechanism 13 and is conveyed downward by the pull-down belt mechanism 14. The amount of the film F that is reeled out from the film roll FR is thereby conveyed in the film supply unit 4. The control unit controls the shaft drive motor to change the rotation speed of the air shaft 21, and the conveyance speed of the film F reeled out from the film roll FR can thereby be adjusted.

### (3-2) Tension Rollers

The tension rollers 22 are arranged in predetermined positions at a predetermined separation interval. The tension rollers 22 guide the film F to the printing device 23 while bending the film F reeled out from the film roll FR to vary the conveyance angle thereof. The tension rollers 22 apply an appropriate tension to the film F that is reeled out from the film roll FR and conveyed, and prevent slackness and meandering of the conveyed film F. The number and positioning of the tension rollers 22 can be arbitrarily set in accordance with the position of the film roll FR, the dimensions of the film F and the like.

At least some of the tension rollers 22 can be movable in the vertical direction. The tension on the film F that is guided by the tension rollers 22 can be adjusted by moving the tension rollers 22. In this case, the control unit detects the tension state of the film F on the basis of the amount of vertical displacement of the tension rollers 22. On the basis of the detected tension state, the control unit then controls the shaft drive motor to adjust the conveyance speed of the film F so that the tension on the film F is within a predetermined range.

### (3-3) Printing Device

The printing device 23 comprises mainly a print head 23a and a retaining part 23b. The print head 23a prints predetermined printing information on the surface of the film F. The printing information is printed in a predetermined printing region on the surface of the film F. When the package contents C are a food, for example, the printing information is a manufacturing date and an expiration date of the package contents C. The printing information is transmitted from the control unit to the printing device 23. The print head 23a can move along the direction toward the film F or away from the film F during printing of the printing information.

The retaining part 23b retains platens 23c, 23d. The platens 23c, 23d are members for receiving the film F. When the print head 23a prints the printing information on the surface of the film F, the print head 23a presses the film F toward the platens 23c, 23d. The platens 23c, 23d are formed from rubber or another elastic member, for example.

In the present embodiment, a platen roller 23c and a platen plate 23d are used as the platens 23c, 23d. In the continuous mode, the platen roller 23c is used. In the intermittent mode, the platen plate 23d is used. The retaining part 23b retains either a platen roller 23c or a platen plate 23d. In FIG. 4, the retaining part 23b retains the platen roller 23c. In FIG. 5, the retaining part 23b retains the platen plate 23d.

The platens 23c, 23d retained by the retaining part 23b are arranged facing the print head 23a at a position in which the film F is disposed between the platens 23c, 23d and the print head 23a. The film F reeled out from the film roll FR and conveyed passes between the print head 23a and the platens 23c, 23d, and is sent to the bag-making and packaging unit 3.

While the print head 23a is pressing the film F toward the platens 23c, 23d, the film F is disposed between the print head 23a and the platens 23c, 23d.

The retaining part 23b retains at least one of the platen roller 23c and the platen plate 23d so that the platen roller 23c and the print head 23a face each other in the continuous mode (first printing mode), and so that the platen plate 23d and the print head 23a face each other in the intermittent mode (second printing mode).

### (3-4) Inspection Device

The inspection device 24 is arranged in the vicinity of a downstream side of the printing device 23. The inspection device 24 inspects whether the printing information in the printing region of the film F is correctly printed. The inspection device 24 is an optical sensor constituted from a light-emitting element and a light-receiving element. The conveyed film F passes between the light-emitting element and the light-receiving element. The light-emitting element radiates light to the printing region of the film F. The light-receiving element senses light that is reflected by the printing region and detects the position of the printing information printed in the printing region and the like.

The inspection device 24 can also be an optical camera. In this case, the inspection device 24 inspects whether the printing information is correctly printed in the printing region by capturing an image of the printing region of the conveyed film F and analyzing the acquired image.

### (3-5) Feed Rollers

The feed rollers 25, 26 guide the film F conveyed in the film supply unit 4 in a predetermined direction. In the present embodiment, a first feed roller 25 and a second feed roller 26 are used as the feed rollers 25, 26. The first feed roller 25 is arranged between the tension rollers 22 and the printing device 23 in the path in which the film F is conveyed, and guides the film F in the direction of the printing device 23. The first feed roller 25 guides the film F between the print head 23a and the platens 23c, 23d. The second feed roller 26 is arranged between the printing device 23 and the inspection device 24 in the path in which the film F is conveyed, and guides the film F in the direction of the inspection device 24.

As illustrated in FIGS. 4 and 5, the positions of the feed rollers 25, 26 in the continuous mode are different from the positions of the feed rollers 25, 26 in the intermittent mode. The positions of the feed rollers 25, 26 are controlled by an air cylinder or other drive mechanism (not illustrated). The control unit automatically switches the positions of the feed rollers 25, 26 in accordance with the operating mode.

The number and positioning of the feed rollers 25, 26 can be arbitrarily set in accordance with the configuration of the film supply unit 4 and the like. Depending upon the configuration of the film supply unit 4, the film supply unit 4 need not be provided with the feed rollers 25, 26.

### (4) Operation of the Bag-Making and Packaging Apparatus

### (4-1) Overall Operation

The operation whereby the bag-making and packaging apparatus 1 seals package contents C in a bag B is summarized below. The film F supplied to the bag-making and packaging unit 3 from the film supply unit 4 is wrapped about the tube 13a and shaped into a tube shape, and is conveyed downward by the pull-down belt mechanism 14. The film F, in the shape of a cylinder wrapped about the tube 13a, is made to overlap at both ends extending in the up-down direction. The overlapping portions of the cylindrically shaped film F are sealed in the longitudinal direction by the longitudinal sealing mechanism 15, forming the cylindrical film Fc.

The longitudinally sealed cylindrical film Fc is removed from the tube 13a and conveyed downward to the transverse sealing mechanism 17. Using the pair of first sealing jaws 51a, 51b or the pair of second sealing jaws 52a, 52b, the transverse sealing mechanism 17 sandwiches and transversely seals the cylindrical film Fc. At this time, a bag B in which package contents C are enclosed is formed below the transversely sealed portion of the cylindrical film Fc. Meanwhile, above the transversely sealed portion of the cylindrical film Fc, package contents C weighed out by the combination weighing unit 2 are dropped into the tube 13a and charged into the cylindrical film Fc.

The transversely sealed portion of the cylindrical film Fc is cut in the transverse direction by a cutter (not illustrated) which is built into the first sealing jaw 51a or the second sealing jaw 52a, in accordance with the timing at which the cylindrical film Fc is transversely sealed. In so doing, the bag B in which the package contents C are sealed is cut away from the trailing cylindrical film Fc.

In this way, bags B in which the package contents C are sealed are manufactured continuously. The manufactured bags B are then transported to a thickness checker, a weight checker, and other devices by a belt conveyor (not illustrated) or the like.

The bag-making and packaging apparatus 1 can also make bags in a form in which a plurality of bags B are linked in a continuous package. In this case, the transversely sealed portion of the cylindrical film Fc is cut in the transverse direction each time that a predetermined number of bags B are formed by the transverse sealing mechanism 17.

The bag-making and packaging apparatus 1 of the present embodiment operates in either a continuous operating mode or an intermittent operating mode. In the continuous mode, the transverse sealing mechanism 17 transversely seals the cylindrical film Fc under conveyance while the transverse sealing mechanism 17 moves downward in accordance with the downward conveyance of the cylindrical film Fc. In the intermittent mode, at the timing at which conveyance of the cylindrical film Fc is temporarily stopped, the transverse sealing mechanism 17 transversely seals the stopped cylindrical film Fc.

The bag-making and packaging apparatus 1 is configured so that the operating mode can be switched between the continuous mode and the intermittent mode. For example, when the bag-making and packaging apparatus 1 is making bags in the form of a continuous package as described above and the manufacturing capacity thereof is increased, manufacturing capacity can sometimes be higher in the intermittent mode than in the continuous mode. Therefore, by making it possible to switch between the continuous mode and the intermittent mode, an operator of the bag-making and packaging apparatus 1 is enabled to select the appropriate operating mode in accordance with the situation.

### (4-2) Operation of the Film Supply Unit

The film supply unit 4 reels out and conveys the film F from the film roll FR fixed to the air shaft 21, and supplies the film F to the shaping mechanism 13 of the bag-making and packaging unit 3. First, the film supply unit 4 conveys the film F reeled out from the film roll FR while guiding the film F in the tension rollers 22. Then, the film F is guided in the direction of the printing device 23 by the first feed roller 25 in the film supply unit 4. The printing information is then printed in the printing region of the film F by the printing device 23 in the film supply unit 4. The film F is then guided in the direction of the inspection device 24 by the second feed roller 26 in the film supply unit 4. Then, through use of the inspection device 24, the film supply unit 4 inspects whether the printing information in the printing region of the film F is correctly printed. The film supply unit 4 then sends the film F to the shaping mechanism 13 of the bag-making and packaging unit 3.

In the continuous mode (first printing mode), while the printing device 23 is printing in the printing region of the film F, the film F is conveyed and the print head 23a does not move along the conveyance direction of the film F. In the intermittent mode (second printing mode), however, while the printing device 23 is printing in the printing region of the film F, conveyance of the film F is stopped and the print head 23a moves along the conveyance direction of the film F. In this manner, in both the continuous mode and the intermittent mode, the print head 23a moves relative to the film F in the conveyance direction of the film F, and the printing information is thereby printed in the printing region of the film F.

(5) Configuration of the Retaining Part

In the bag-making and packaging apparatus 1, it is possible to switch between the continuous mode and the intermittent mode. The bag-making and packaging apparatus 1 can use the same bag-making and packaging unit 3 in both the continuous operating mode and the intermittent operating mode. However, the printing device 23 of the film supply unit 4 uses the platen roller 23c in the continuous mode, and uses the platen plate 23d in the intermittent mode. The bag-making and packaging apparatus 1 therefore has a retaining part 23b to make it possible to use the platen 23c, 23d that is appropriate in accordance with the operating mode.

The retaining part 23b is configured so as to be capable of retaining the platen roller 23c or the platen plate 23d in the appropriate position in accordance with the operating mode of the bag-making and packaging apparatus 1. In the case of the continuous mode, the retaining part 23b retains the platen roller 23c so that the print head 23a and the platen roller 23c face each other with the film F disposed therebetween. In the case of the intermittent mode, the retaining part 23b retains the platen plate 23d so that the print head 23a and the platen plate 23d face each other with the film F disposed therebetween.

The platen roller 23c and the platen plate 23d are configured so as to be attachable to and detachable from the retaining part 23b. An operator of the bag-making and packaging apparatus 1 can thereby change the platen 23c, 23d that is retained by the retaining part 23b when switching the operating mode. For example, when switching from the continuous mode to the intermittent mode, the operator of the bag-making and packaging apparatus 1 removes the platen roller 23c from the retaining part 23b and attaches the platen plate 23d to the retaining part 23b. When switching from the intermittent mode to the continuous mode, the operator of the bag-making and packaging apparatus 1 can remove the platen plate 23d from the retaining part 23b and attach the platen roller 23c to the retaining part 23b.

The retaining part 23b can be fixed to the film supply unit 4, or can be configured so as to be attachable to and detachable from the film supply unit 4. When the retaining part 23b is attachable to and detachable from the film supply unit 4, the operator of the bag-making and packaging apparatus 1 can change the platen 23c, 23d that is retained by the retaining part 23b after removing the retaining part 23b from the film supply unit 4 during switching of the operating mode.

### (6) Characteristics

The bag-making and packaging apparatus 1 has a retaining part 23b that is capable of retaining the platen roller 23c or the platen plate 23d in the appropriate position in accordance with the operating mode. An operator of the bag-making and packaging apparatus 1 can therefore easily change the platens 23c, 23d that are used during printing on the film F, in accordance with the operating mode.

The bag-making and packaging apparatus 1 can also use a common print head 23a, regardless of the operating mode. It is therefore unnecessary to provide the bag-making and packaging apparatus 1 with both a printing device that is only for the continuous mode and a printing device that is only for the intermittent mode. Therefore, because there is no need for a space to mount two printing devices to correspond to each of the continuous mode and the intermittent mode, installation space and cost can be reduced.

### Second Embodiment

A bag-making and packaging apparatus 1 according to a second embodiment of the present invention will be described, focusing on the differences between the second embodiment and the bag-making and packaging apparatus 1 according to the first embodiment. The bag-making and packaging apparatus 1 of the present embodiment comprises a printing device 123. The constituent elements other than the printing device 123 are the same as in the first embodiment.

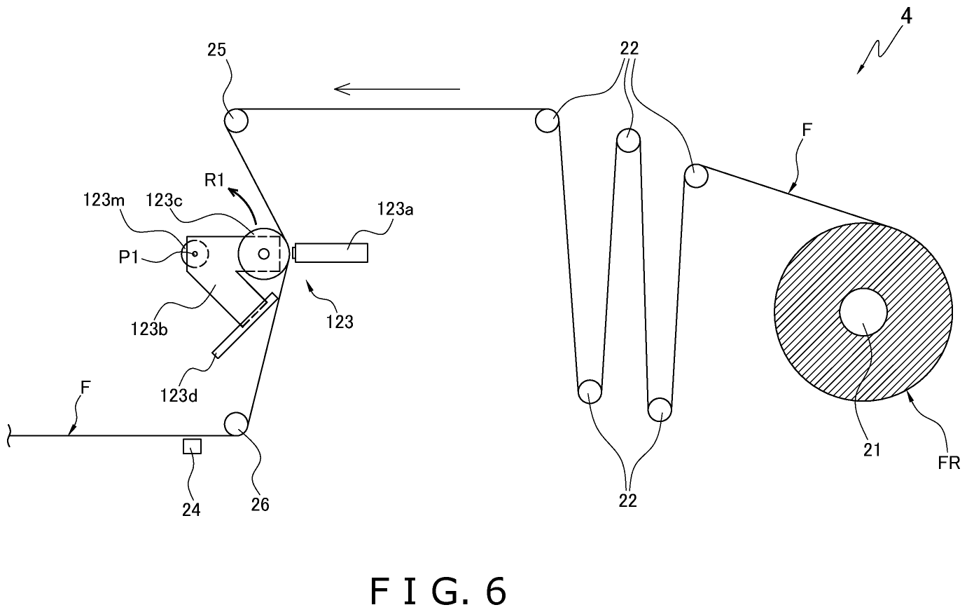

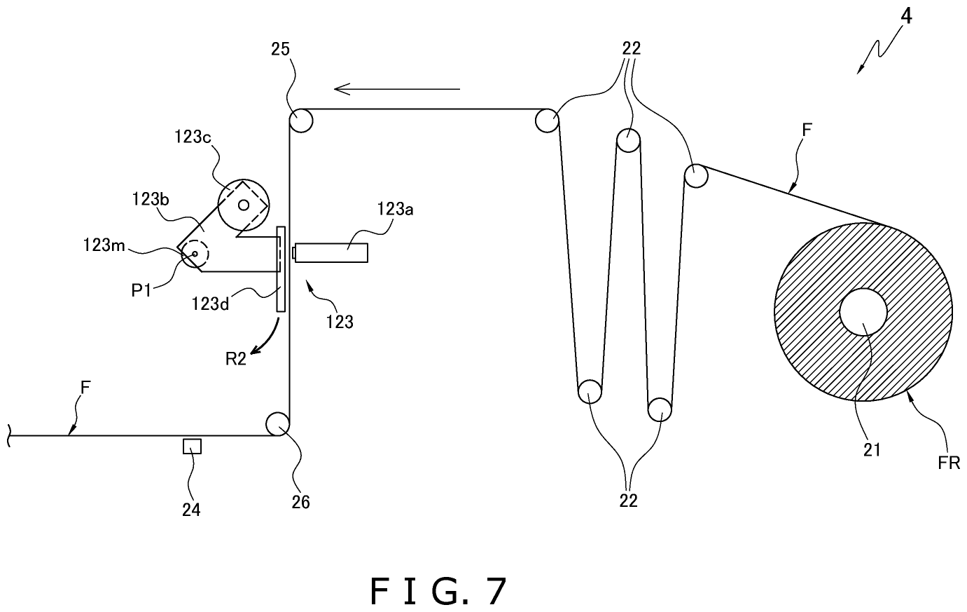

FIGS. 6 and 7 are side views showing a simplified configuration of the film supply unit 4 of the present embodiment, in the same manner as FIGS. 4 and 5. FIG. 6 illustrates a configuration in the continuous mode. FIG. 7 illustrates a configuration in the intermittent mode.

The printing device 123 comprises mainly a print head 123a, a switching part 123b, and a switching motor 123m. The print head 123a is the same as the print head 23a of the first embodiment. The switching part 123b retains a platen roller 123c and a platen plate 123d. The platen roller 123c and the platen plate 123d are the same as the platen roller 23c and the platen plate 23d, respectively, of the first embodiment. The switching part 123b is attached to the film supply unit 4.

The switching part 123b is configured so as to be able to switch between a first printing state and a second printing state. The first printing state is, as shown in FIG. 6, a continuous-mode state in which the platen roller 123c and the print head 123a face each other with the film F disposed therebetween. The second printing state is, as shown in FIG. 7, an intermittent-mode state in which the platen plate 123d and the print head 123a face each other with the film F disposed therebetween.

In the present embodiment, the switching part 123b is configured so as to switch between the first printing state and the second printing state by causing the platen roller 123c and/or the platen plate 123d to move. Specifically, the operator of the bag-making and packaging apparatus 1 can switch between the first printing mode and the second printing mode by operating the switching part 123b when switching the operating mode of the bag-making and packaging apparatus 1. The switching part 123b is configured so as to be manually movable by the operator. A specific example of the configuration of the switching part 123b will next be described with reference to the drawings.

FIGS. 6 and 7 illustrate an example of the switching part 123b. The switching part 123b illustrated in FIGS. 6 and 7 retains both the platen roller 123c and the platen plate 123d in advance. In the switching part 123b, a portion in which the platen roller 123c is retained and a portion in which the platen plate 123d is retained are joined to each other. The operator of the bag-making and packaging apparatus 1 can therefore move both the platen roller 123c and the platen plate 123d integrally by moving the switching part 123b as a whole. In FIGS. 6 and 7, the switching part 123b can be rotated about a point P1 along arrows R1, R2 by the switching motor 123m. The switching part 123b is thereby configured so as to be able to move the platen roller 123c and the platen plate 123d along the film F.

In the continuous mode in FIG. 6, the operator can switch the operating mode from the continuous mode to the intermittent mode by moving the switching part 123b along the arrow R1 shown in FIG. 6. In the intermittent mode in FIG. 7, the operator can switch the operating mode from the intermittent mode to the continuous mode by moving the switching part 123b along the arrow R2 shown in FIG. 7. The operator can thereby switch between the first printing state and the second printing state by moving the switching part 123b.

In the present embodiment, the switching motor 123m can cause the switching part 123b to rotate. Specifically, a rotating shaft of the switching motor 123m is connected to the point P1, and the switching part 123b rotates about the point P1 in accordance with an amount of rotation of the rotating shaft.

In the first printing state in FIG. 6, the rotating shaft of the switching motor 123m rotates by a first angle in the direction of the arrow R1, and the switching part 123b thereby rotates in the direction of the arrow R1 and changes to the second printing state in FIG. 7.

In the second printing state in FIG. 7, the rotating shaft of the switching motor 123m rotates by the first angle in the direction of the arrow R2, and the switching part 123b thereby rotates in the direction of the arrow R2 and changes to the first printing state in FIG. 6.

A servo motor is employed as the switching motor 123m in the present embodiment, but the switching motor 123m is not limited to a servo motor, and another motor, e.g., a stepping motor, can be employed.

### Third Embodiment

A bag-making and packaging apparatus 1 according to a third embodiment of the present invention will be described, focusing on the differences between the third embodiment and the bag-making and packaging apparatus 1 according to the second embodiment. The bag-making and packaging apparatus 1 of the present embodiment comprises the printing device 123 of the second embodiment illustrated in FIGS. 6 and 7. The constituent elements other than the printing device 123 are the same as in the second embodiment.

### (1) Configuration of the Control Unit 7

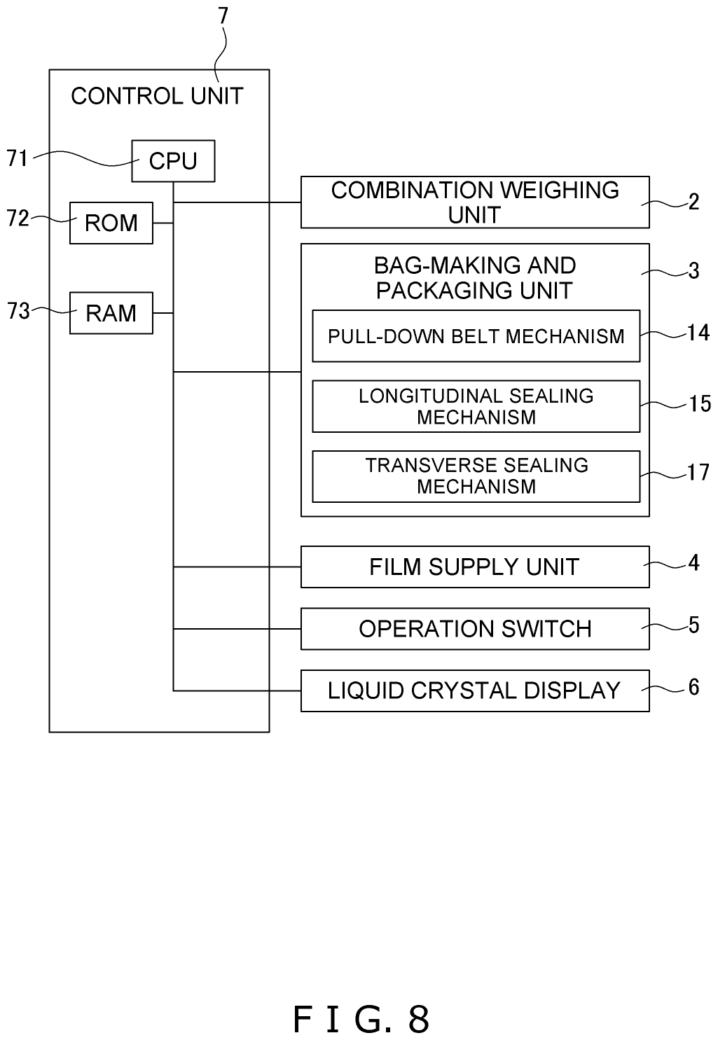

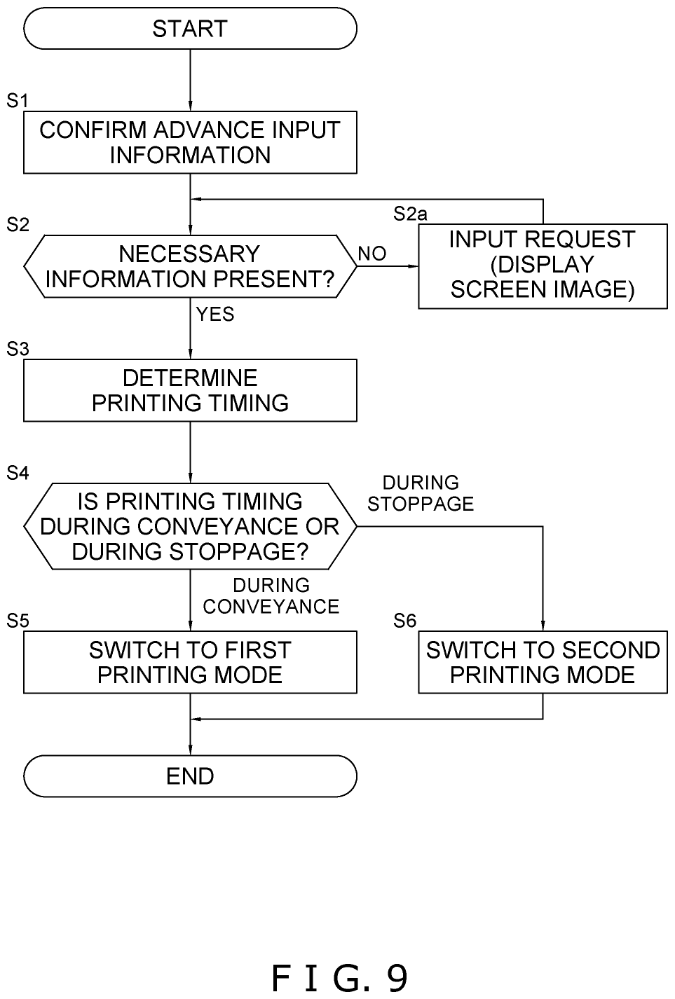

The bag-making and packaging apparatus 1 of the present embodiment comprises a control unit 7. FIG. 8 is a block diagram showing the control unit 7. In FIG. 9, the control unit 7 is constituted from a CPU 71, and ROM 72, RAM 73, etc., connected to the CPU 71. The control unit 7 is connected to the combination weighing unit 2, the bag-making and packaging unit 3, the film supply unit 4, the operation switch 5, and the liquid crystal display 6.

On the basis of input from the operation switch 5 and the liquid crystal display 6, the control unit 7 controls the combination weighing unit 2, the pull-down belt mechanism 14 of the bag-making and packaging unit 3, the longitudinal sealing mechanism 15, the transverse sealing mechanism 17, and the film supply unit 4, and outputs information of various kinds to the liquid crystal display 6.

### (2) Operation of the Bag-Making and Packaging Apparatus

### (2-1) Overall Operation

The operation whereby the bag-making and packaging apparatus 1 seals package contents C in a bag B is summarized below with reference to FIGS. 1, 2, and 3. The film F supplied to the bag-making and packaging unit 3 from the film supply unit 4 is wrapped about the tube 13a and shaped into a tube shape, and is conveyed downward by the pull-down belt mechanism 14.

The film F, in the shape of a cylinder wrapped about the tube 13a, is made to overlap at both ends extending in the up-down direction. The overlapping portions of the cylindrically shaped film F are sealed in the longitudinal direction by the longitudinal sealing mechanism 15, forming the cylindrical film Fc.

The longitudinally sealed cylindrical film Fc is removed from the tube 13a and conveyed downward to the transverse sealing mechanism 17. Using the pair of first sealing jaws 51a, 51b or the pair of second sealing jaws 52a, 52b, the transverse sealing mechanism 17 sandwiches and transversely seals the cylindrical film Fc. At this time, a bag B in which package contents C are enclosed is formed below the transversely sealed portion of the cylindrical film Fc.

Meanwhile, above the transversely sealed portion of the cylindrical film Fc, package contents C weighed out by the combination weighing unit 2 are dropped into the tube 13a and charged into the cylindrical film Fc

The transversely sealed portion of the cylindrical film Fc is cut in the transverse direction by a cutter (not illustrated) which is built into the first sealing jaw 51a or the second sealing jaw 52a, in accordance with the timing at which the cylindrical film Fc is transversely sealed. In so doing, the bag B in which the package contents C are sealed is cut away from the trailing cylindrical film Fc.

In this way, the bags B in which the package contents C are sealed are manufactured continuously. The manufactured bags B are then transported to a thickness checker, a weight checker, and other devices by a belt conveyor (not illustrated) or the like.

The bag-making and packaging apparatus 1 of the present embodiment operates in either a continuous conveyance mode or an intermittent conveyance mode.

In the continuous conveyance mode, the transverse sealing mechanism 17 transversely seals the cylindrical film Fc under conveyance while the transverse sealing mechanism 17 moves downward in accordance with the downward conveyance of the cylindrical film Fc.

In the intermittent conveyance mode, at the timing at which conveyance of the cylindrical film Fc is temporarily stopped, the transverse sealing mechanism 17 transversely seals the stopped cylindrical film Fc.

The bag-making and packaging apparatus 1 is configured so that either the continuous conveyance mode or the intermittent conveyance mode can be selected as the operating mode, and the operator of the bag-making and packaging apparatus 1 can select the appropriate operating mode in accordance with the situation.

### (2-2) Operation of the Film Supply Unit 4

### (2-2-1) Switching the Printing Mode

FIG. 9 is a flowchart of printing mode switching control performed before operation of the film supply unit 4.

Each step of the abovementioned control will be described with reference to FIG. 9.

### (Step S1)

In step 51, the control unit 7 confirms advance input information. The advance input information is information that an operator inputs via the operation switch 5 and the liquid crystal display 6 prior to starting operation of the bag-making and packaging apparatus 1.

### (Step S2)

Then, in step S2, the control unit 7 determines whether necessary information for selecting the printing mode has been inputted in the advance input information. The necessary information in this case is a printing position, a bag length, and the operating mode.

The process proceeds to step S3 when the control unit 7 determines that the necessary information has been inputted. When the control unit 7 determines that the necessary information has not been inputted, the process proceeds to step S2a, and an “input request” indicating that the necessary information is not included in the advance input information is displayed in the liquid crystal display 6 to prompt input of the necessary information.

### (Step S3)

Then, in step S3, the control unit 7 determines a printing timing. The printing timing determines whether printing is performed while the film F is being conveyed, or printing is performed while the film F is stopped.

When the control unit 7 recognizes from the necessary information acquired in step S2 that the operating mode is a continuous conveyance mode, the control unit 7 determines to perform printing while the film F is being conveyed.

When the control unit 7 recognizes from the necessary information acquired in step S2 that the operating mode is an intermittent conveyance mode, the control unit 7 determines the printing timing on the basis of the printing position. Printing is generally performed while the film F is stopped when the operating mode is the intermittent conveyance mode.

However, due to the relationship between the printing position and the bag length, it is sometimes decided to perform printing while the film F is being conveyed even in the intermittent conveyance mode.

### (Step S4)

Then, in step S4, the control unit 7 determines whether the printing timing is to be during conveyance of the film F or during stopping of the film F, the process proceeds to step S5 when it is determined that the printing timing is to be during conveyance of the film F, and the process proceeds to step S6 when it is determined that the printing timing is to be during stopping of the film F.

### (Step S5)

Because it was determined that the printing timing is to be during conveyance of the film F, the control unit 7 then switches the printing mode to the first printing mode in step S5. Specifically, the control unit 7 causes the switching motor 123m of the switching part 123b to rotate, and places the switching part 123b in a first printing state in which the platen roller 123c and the print head 123a face each other with the film F disposed therebetween, as illustrated in FIG. 6.

### (Step S6)

Meanwhile, when the control unit 7 determines that the printing timing is to be during stopping of the film F, the control unit 7 switches the printing mode to the second printing mode in step S6. Specifically, the control unit 7 causes the switching motor 123m of the switching part 123b to rotate, and places the switching part 123b in a second printing state in which the platen plate 123d and the print head 123a face each other with the film F disposed therebetween, as illustrated in FIG. 7.

Because the printing mode is automatically switched in advance on the basis of the printing timing as described above, erroneous selection of the printing mode is prevented.

### (2-2-2) Operation After Printing Mode Switching

The film supply unit 4 reels out and conveys the film F from the film roll FR fixed to the air shaft 21, and supplies the film F to the shaping mechanism 13 of the bag-making and packaging unit 3. First, the film supply unit 4 conveys the film F reeled out from the film roll FR while guiding the film F in the tension rollers 22.

Then, the film F is guided in the direction of the printing device 123 by the first feed roller 25 in the film supply unit 4. The printing information is then printed in the printing region of the film F by the printing device 123 in the film supply unit 4.

The film F is then guided in the direction of the inspection device 24 by the second feed roller 26 in the film supply unit 4.

Then, through use of the inspection device 24, the film supply unit 4 inspects whether the printing information in the printing region of the film F is correctly printed.

The film supply unit 4 then sends the film F to the shaping mechanism 13 of the bag-making and packaging unit 3.

In the first printing mode, while the printing device 123 is printing in the printing region of the film F, the film F is conveyed and the print head 123a does not move along the conveyance direction of the film F.

In the second printing mode, however, while the printing device 123 is printing in the printing region of the film F, conveyance of the film F is stopped and the print head 123a moves along the conveyance direction of the film F.

In this manner, the print head 123a moves relative to the film F in the conveyance direction of the film F, and the printing information is thereby printed in the printing region of the film F.

### (3) Characteristics

(3-1)

In the bag-making and packaging apparatus 1, when the control unit 7 determines on the basis of the advance input information that the timing of printing on the film F is during conveyance of the film F, the printing mode is switched to the first printing mode. When the control unit 7 determines on the basis of the advance input information that the timing of printing on the film F is during stoppage of the film F, the printing mode is switched to the second printing mode.

Because the printing mode is decided according to the timing of printing on the packaging material regardless of whether bags are manufactured continuously or intermittently, there is no need for the operator to be conscious of which printing mode to operate in, and the printing mode that is suited for production is selected, thereby preventing misoperation.

(3-2)

The advance input information includes the printing position on the film F and the bag length. The printing position on the film F and the bag length are items of information that are inputted to the bag-making and packaging apparatus 1 prior to production and are unlikely to not be inputted, and the information necessary for switching the printing mode is reliably obtained.

(3-3)

The control unit 7 has the continuous conveyance mode and the intermittent conveyance mode as conveyance modes that can be selected for conveying the film F. the continuous conveyance mode is a mode in which the film F is continuously conveyed. The intermittent conveyance mode is a mode in which the film F is intermittently conveyed. A conveyance mode selection result is also included in the advance input information.

(3-4)

When the control unit 7 determines that the conveyance mode is the intermittent conveyance mode, and that the timing of printing on the film F is during conveyance of the film F, the control unit 7 switches the printing mode to the first printing mode. Because the printing mode is switched according to whether the printing timing is during conveyance or during stopping of the film F, even in the intermittent conveyance mode, the printing mode that is suited for production is selected.

### Fourth Embodiment

A bag-making and packaging apparatus 1 according to a fourth embodiment of the present invention will be described, focusing on the differences between the fourth embodiment and the bag-making and packaging apparatus 1 according to the third embodiment. The bag-making and packaging apparatus 1 of the fourth embodiment comprises a printing device 223. The constituent elements other than the printing device 223 are the same as in the third embodiment.

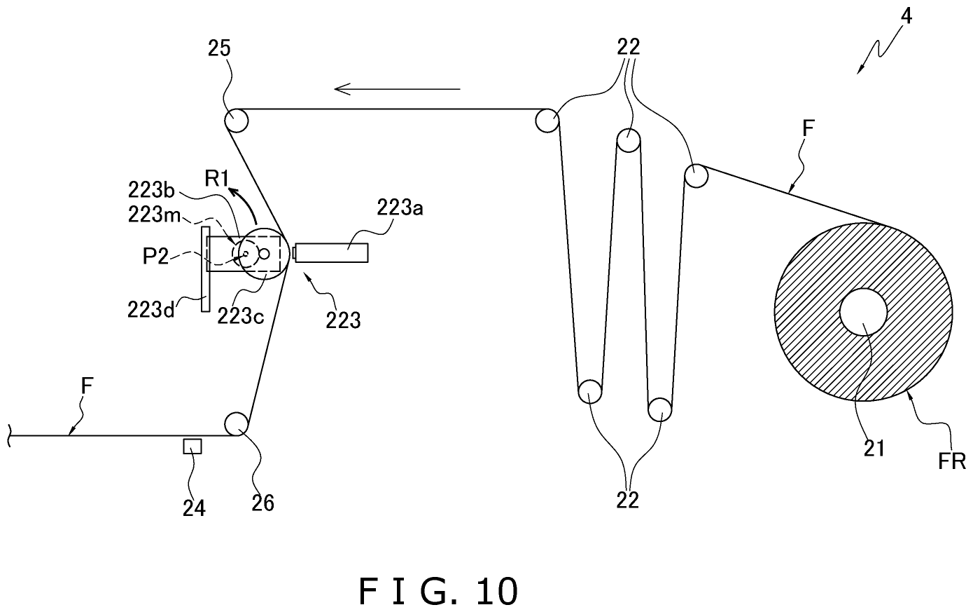

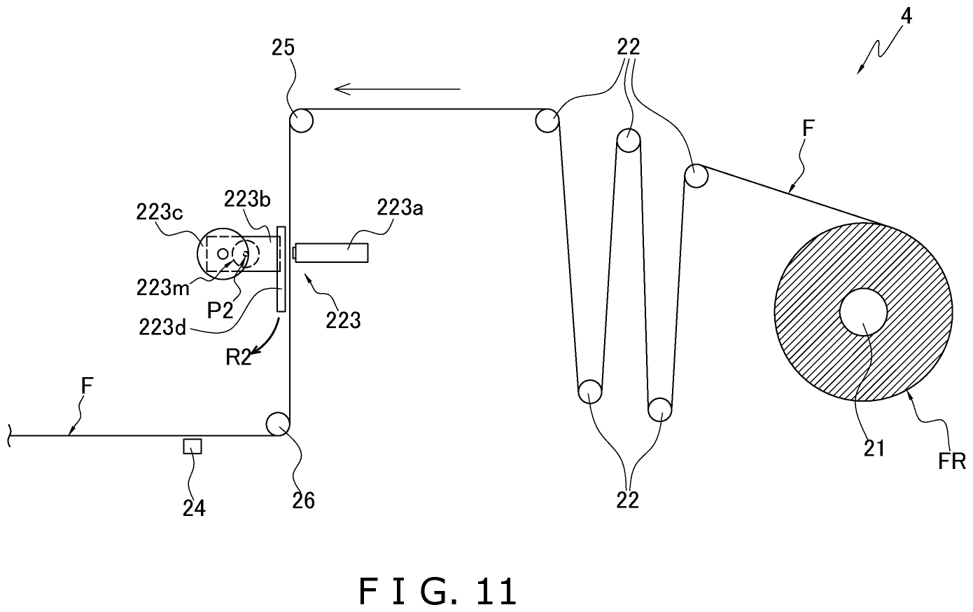

FIG. 10 is a simplified side view of the film supply unit 4 when the printing device 223 of the bag-making and packaging apparatus 1 according to the fourth embodiment is operating in the first printing mode. FIG. 11 is a simplified side view of the film supply unit 4 when the printing device 223 of the bag-making and packaging apparatus 1 according to the fourth embodiment is operating in the second printing mode.

### (1) Printing Device 223

The printing device 223 comprises mainly a print head 223a and a switching part 223b. The print head 223a prints predetermined printing information on the surface of the film F. The printing information is printed in a predetermined printing region on the surface of the film F.

When the package contents C are a food, for example, the printing information is a manufacturing date and an expiration date of the package contents C. The printing information is transmitted from the control unit 7 to the printing device 223.

### (1-1) Print Head 223a

The print head 223a can move along the direction toward the film F or away from the film F during printing of the printing information.

### (1-2) Switching Part 223b

In the fourth embodiment, a platen roller 223c and a platen plate 223d are retained on respective end parts of the switching part 223b.

The switching part 223b changes the positions at which the platen roller 223c and the platen plate 223d are retained, in accordance with the operating mode of the bag-making and packaging apparatus 1.

In the first printing mode in FIG. 10, the platen roller 223c is retained in a position facing the print head 223a, and the platen plate 223d is retained in a position that is separated from the print head 223a.

In the second printing mode in FIG. 11, the platen plate 223d is retained in a position facing the print head 223a, and the platen roller 223c is retained in a position that is separated from the print head 223 a.

### (1-3) Switching Motor 223m

A switching motor 223m can cause the switching part 223b to rotate. Specifically, a rotating shaft of the switching motor 223m is connected to the point P2, and the switching part 223b rotates about the point P2 in accordance with an amount of rotation of the rotating shaft.

In the first printing state (first printing mode) in FIG. 10, the rotating shaft of the switching motor 223m rotates by a second angle in the direction of the arrow R1, and the switching part 223b thereby rotates in the direction of the arrow R1 and changes to the second printing state (second printing mode) in FIG. 11.

In the second printing state (second printing mode) in FIG. 11, the rotating shaft of the switching motor 223m rotates by the second angle in the direction of the arrow R2, and the switching part 223b thereby rotates in the direction of the arrow R2 and changes to the first printing state (first printing mode) in FIG. 10.

A servo motor is employed as the switching motor 223m in the present embodiment, but the switching motor 223m is not limited to a servo motor, and another motor, e.g., a stepping motor, can be employed.

An operator of the bag-making and packaging apparatus 1 can exchange the positions at which the platen roller 223c and the platen plate 223d are retained, without touching the platen roller 223c and the platen plate 223d.

“Switching the printing mode” and the “operation after printing mode switching” are the same as in the third embodiment, and will not be described herein.

### Fifth Embodiment

A bag-making and packaging apparatus 1 according to a fifth embodiment of the present invention will be described, focusing on the differences between the fifth embodiment and the bag-making and packaging apparatus 1 according to the third embodiment. The bag-making and packaging apparatus 1 of the fifth embodiment comprises a printing device 323. The constituent elements other than the printing device 323 are the same as in the third embodiment.

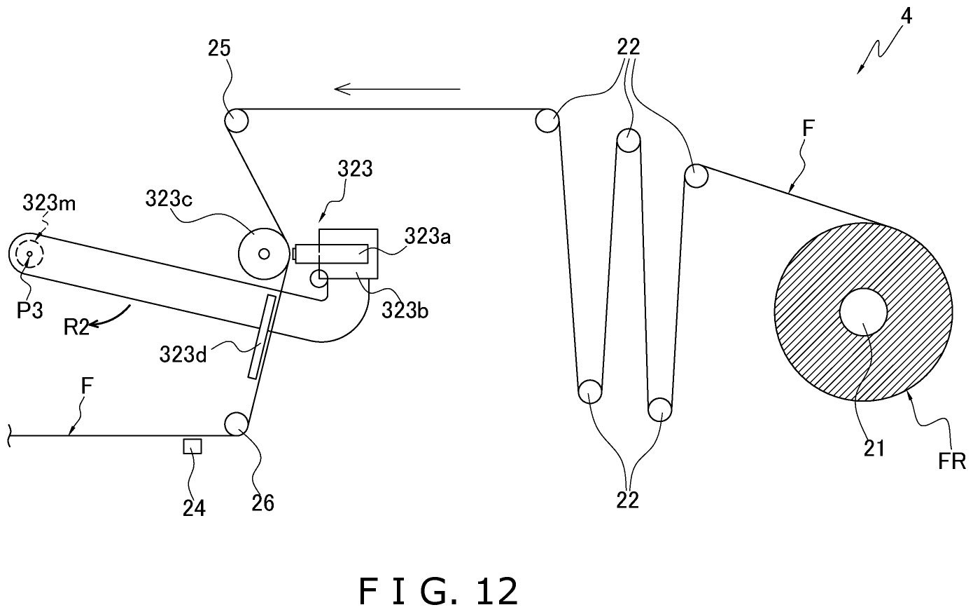

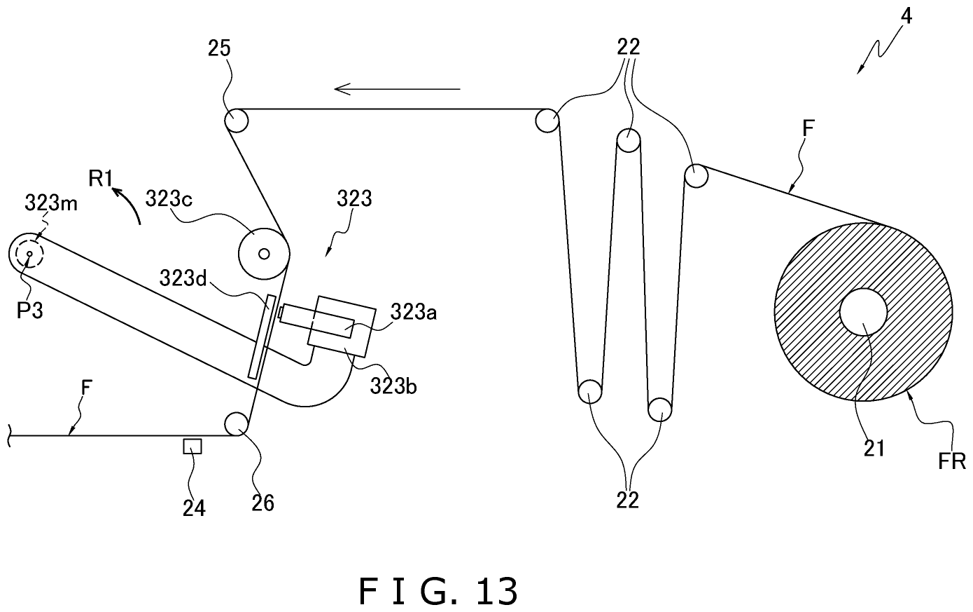

FIG. 12 is a simplified side view of the film supply unit 4 when the printing device 323 of the bag-making and packaging apparatus 1 according to the fifth embodiment is operating in the first printing mode. FIG. 13 is a simplified side view of the film supply unit 4 when the printing device 323 of the bag-making and packaging apparatus 1 according to the fifth embodiment is operating in the second printing mode.

### (1) Printing Device 323

The printing device 323 comprises mainly a print head 323a and a switching part 323b. The print head 323a prints predetermined printing information on the surface of the film F. The printing information is printed in a predetermined printing region on the surface of the film F.

When the package contents C are a food, for example, the printing information is a manufacturing date and an expiration date of the package contents C. The printing information is transmitted from the control unit 7 to the printing device 223.

### (1-1) Print Head 323a

The print head 323a can move along the direction toward the film F or away from the film F during printing of the printing information.

### (1-2) Switching Part 323b

In the third embodiment and the fourth embodiment, the switching part 323b switched between the first printing state and the second printing state by rotating the platen roller 323c and the platen plate 323d. In the fifth embodiment, however, the print head 323a switches between the first printing state and the second printing state by moving.

As indicated in FIGS. 12 and 13, the positions of the platen roller 323c and the platen plate 323d are fixed. The print head 323a can move between the position of the print head 323a in the first printing mode illustrated in FIG. 12 and the position of the print head 323a in the second printing mode illustrated in FIG. 13.

### (1-3) Switching Motor 323m

A switching motor 323m can cause the print head 323a to move. Specifically, a rotating shaft of the switching motor 323m is connected to the point P3, and the print head 323a rotates about the point P3 in accordance with an amount of rotation of the rotating shaft.

In the first printing state (first printing mode) in FIG. 12, the rotating shaft of the switching motor 323m rotates by a third angle in the direction of the arrow R2, and the print head 323a thereby rotates in the direction of the arrow R2 and changes to the second printing state (second printing mode) in FIG. 13.

In the second printing state (second printing mode) in FIG. 13, the rotating shaft of the switching motor 323m rotates by the third angle in the direction of the arrow R1, and the print head 323a thereby rotates in the direction of the arrow R1 and changes to the first printing state (first printing mode) in FIG. 12.

A servo motor is employed as the switching motor 323m in the present embodiment, but the switching motor 323m is not limited to a servo motor, and another motor, e.g., a stepping motor, can be employed.

“Switching the printing mode” and the “operation after printing mode switching” are the same as in the third embodiment, and will not be described herein.

### Sixth Embodiment

Even in an implementation of a bag-making and packaging apparatus in which a platen used in a continuous-type bag-making and packaging apparatus and a platen used in an intermittent-type bag-making and packaging apparatus can be switched for a single printing device, a printing defect is brought about by human error in a case in which the printing state is the second printing state irrespective of an input to switch the printing mode to the first printing mode, or in a case in which the printing state is the first printing state irrespective of an input to switch the printing mode to the second printing mode.

Therefore, such human error is avoided in the third, fourth, and fifth embodiments by adopting a configuration in which a switching motor rotates the platen roller and the platen plate in coordination with switching of the printing mode, and the printing state thereby automatically switches to the first printing state when the first printing mode is in effect, and the printing state automatically switches to the second printing state when the second printing mode is in effect.

When such a defense against human error can be guaranteed, it is also possible for the platen roller and the platen plate to be moved by the operator instead of by a switching motor.

A bag-making and packaging apparatus in which the platen roller and the platen plate are manually switched will be described below.

A bag-making and packaging apparatus 1 according to a sixth embodiment of the present invention will be described, focusing on the differences between the bag-making and packaging apparatus 1 according to the sixth embodiment and the bag-making and packaging apparatus 1 according to the third embodiment. The bag-making and packaging apparatus 1 of the sixth embodiment comprises a printing device 423 and an instruction unit 8 to instruct the control unit 7 to switch the printing mode. Besides comprising a printing device 423 and an instruction unit 8, and not having a switching motor, the present embodiment is the same as the third embodiment.

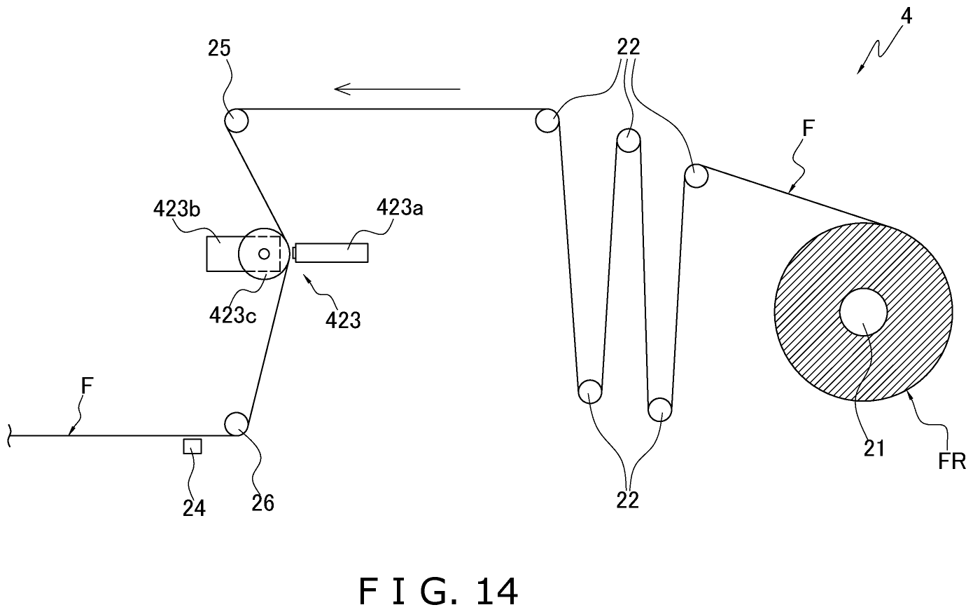

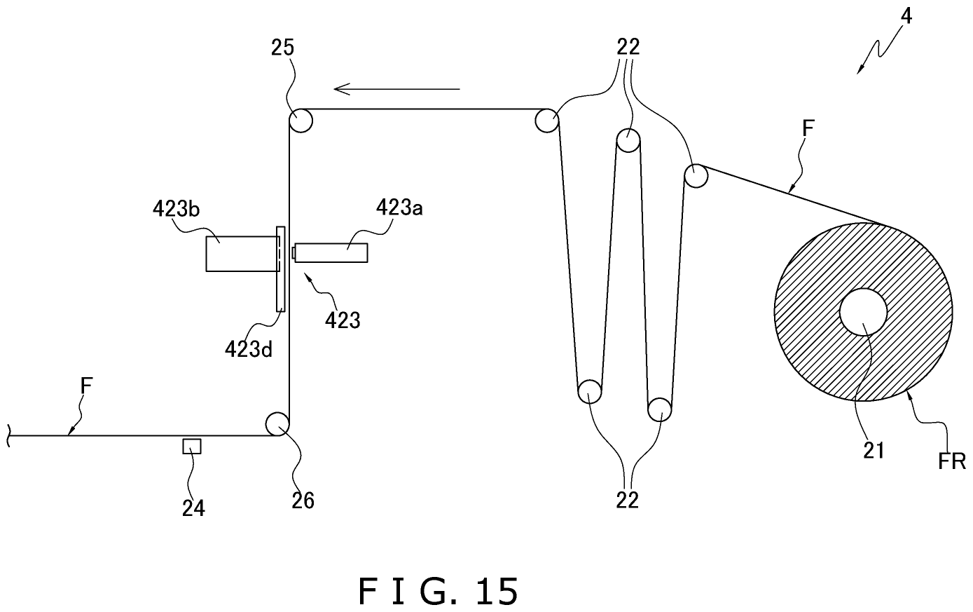

FIG. 14 is a simplified side view of the film supply unit 4 when the printing device 423 of the bag-making and packaging apparatus 1 according to the sixth embodiment is operating in the first printing mode. FIG. 15 is a simplified side view of the film supply unit 4 when the printing device 423 of the bag-making and packaging apparatus 1 according to the sixth embodiment is operating in the second printing mode.

### (1) Printing Device 423

The printing device 423 comprises mainly a print head 423a and a switching part 423b. The print head 423a prints predetermined printing information on the surface of the film F. The printing information is printed in a predetermined printing region on the surface of the film F.

When the package contents C are a food, for example, the printing information is a manufacturing date and an expiration date of the package contents C. The printing information is transmitted from the control unit to the printing device 423.

### (1-1) Print Head 423a

The print head 23a can move along the direction toward the film F or away from the film F during printing of the printing information.

### (1-2) Switching Part 423b

The switching part 423b retains a platen roller 423c or a platen plate 423d. In FIG. 14, the switching part 423b can retain the platen roller 423c. In FIG. 15, the switching part 423b can retain the platen plate 423d.

The platen roller 423c and the platen plate 423d are members for receiving the film F. When the print head 423a prints the printing information on the surface of the film F, the print head 423a presses the film F toward the platen roller 423c or the platen plate 423d. The platen roller 423c and the platen plate 423d are formed from rubber or another elastic member, for example.

In the sixth embodiment, the platen roller 423c is used in the first printing mode, and the platen plate 423d is used in the second printing mode.

The platen roller 423c or the platen plate 423d retained by the switching part 423b is arranged facing the print head 423a at a position in which the film F is disposed between the platen roller 423c or the platen plate 423d and the print head 423a.

The film F reeled out from the film roll FR and conveyed passes between the print head 423a and the platen roller 423c or the platen plate 423d, and is sent to the bag-making and packaging unit 3. While the print head 423a is pressing the film F toward the platen roller 423c or the platen plate 423d, the film F is disposed between the print head 423a and the platen roller 423c or the platen plate 423d.

The switching part 423b retains the platen roller 423c so that the platen roller 423c and the print head 423a face each other in the first printing mode. In the second printing mode, the switching part 423b retains the platen plate 423d so that the platen plate 423d and the print head 423a face each other.

### (2) Instruction Unit 8

The instruction unit 8 specifies the printing mode. As an embodiment of the instruction unit 8, the instruction unit 8 can be a switch to select the printing mode. alternatively, the instruction unit 8 can be embodied by selection via the liquid crystal display.

When the control unit 7 determines on the basis of the advance input information and an instruction from the instruction unit 8 that the timing of printing on the film F is during conveyance of the film F, the control unit 7 issues an instruction via the liquid crystal display 6 to switch the printing mode to the first printing mode.

When the control unit 7 determines that the timing of printing on the film F is during stoppage of the film F, the control unit 7 issues an instruction via the liquid crystal display to switch the printing mode to the second printing mode.

The operator switches the printing mode to the mode that is displayed in the liquid crystal display 6, i.e., to the first printing mode or the second printing mode.

When the printing mode selected by the control unit 7 from the advance input information and the printing mode specified by the instruction unit 8 do not match, the control unit 7 issues a warning via the liquid crystal display 6 to prompt review of the printing mode.

The operator exchanges the platen roller 423c or the platen plate 423d retained by the switching part 423b, in accordance with the printing mode displayed in the liquid crystal display 6.

For example, when the first printing mode is specified, the operator of the bag- making and packaging apparatus 1 removes the platen plate 423d from the switching part 423b and attaches the platen roller 423c to the switching part 423b, placing the switching part 423b in the first printing state.

When the second printing mode is specified, the operator of the bag-making and packaging apparatus 1 removes the platen roller 423c from the switching part 423b and attaches the platen plate 423d to the switching part 423b, placing the switching part 423b in the second printing state.

However, the control unit 7 is configured so that a first signal is inputted to the control unit 7 when the printing state is the first printing state, and a second signal is inputted to the control unit 7 when the printing state is the second printing state.

Consequently, when the printing mode and the printing state do not match, a warning is issued from the control unit 7 via the liquid crystal display 6 to prompt review of the printing state.

### (3) Operation of the Film Supply Unit 4

The film supply unit 4 reels out and conveys the film F from the film roll FR fixed to the air shaft 21, and supplies the film F to the shaping mechanism 13 of the bag-making and packaging unit 3. First, the film supply unit 4 conveys the film F reeled out from the film roll FR while guiding the film F with the tension rollers 22.

Then, the film F is guided in the direction of the printing device 423 by the first feed roller 25 in the film supply unit 4. The printing information is then printed in the printing region of the film F by the printing device 423 in the film supply unit 4.

The film F is then guided in the direction of the inspection device 24 by the second feed roller 26 in the film supply unit 4.

Then, through use of the inspection device 24, the film supply unit 4 inspects whether the printing information in the printing region of the film F is correctly printed.

The film supply unit 4 then sends the film F to the shaping mechanism 13 of the bag-making and packaging unit 3.

In the first printing mode, while the printing device 423 is printing in the printing region of the film F, the film F is conveyed and the print head 423a does not move along the conveyance direction of the film F.

In the second printing mode, however, while the printing device 423 is printing in the printing region of the film F, conveyance of the film F is stopped and the print head 423a moves along the conveyance direction of the film F.

In this manner, the print head 423a moves relative to the film F in the conveyance direction of the film F, and the printing information is thereby printed in the printing region of the film F.

### Seventh Embodiment

A bag-making and packaging apparatus 1 according to a seventh embodiment of the present invention will be described, focusing on the differences between the bag-making and packaging apparatus 1 according to the seventh embodiment and the bag-making and packaging apparatus 1 according to the sixth embodiment. The bag-making and packaging apparatus 1 of the seventh embodiment comprises a printing device 523. The constituent elements other than the printing device 523 are the same as in the third embodiment.

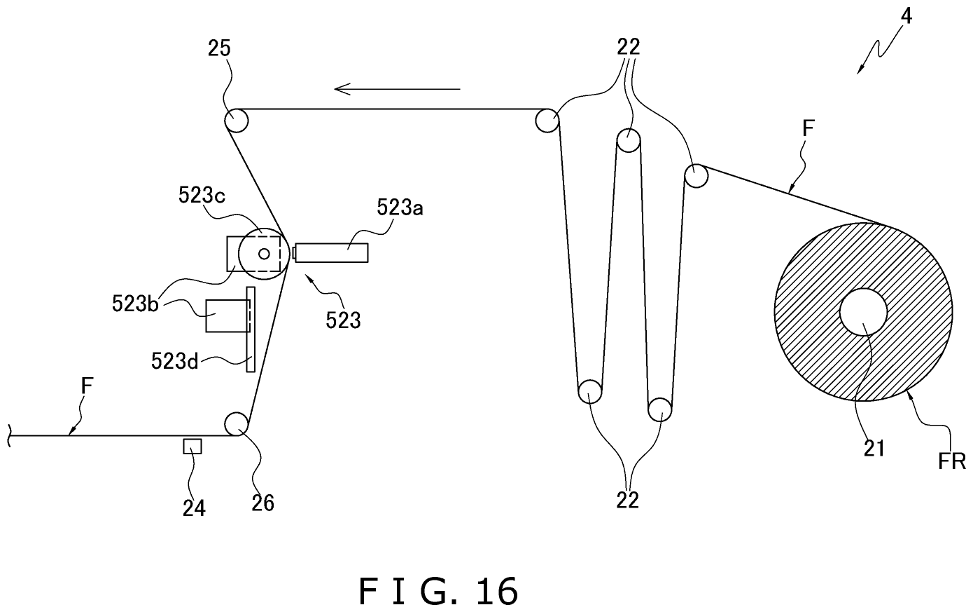

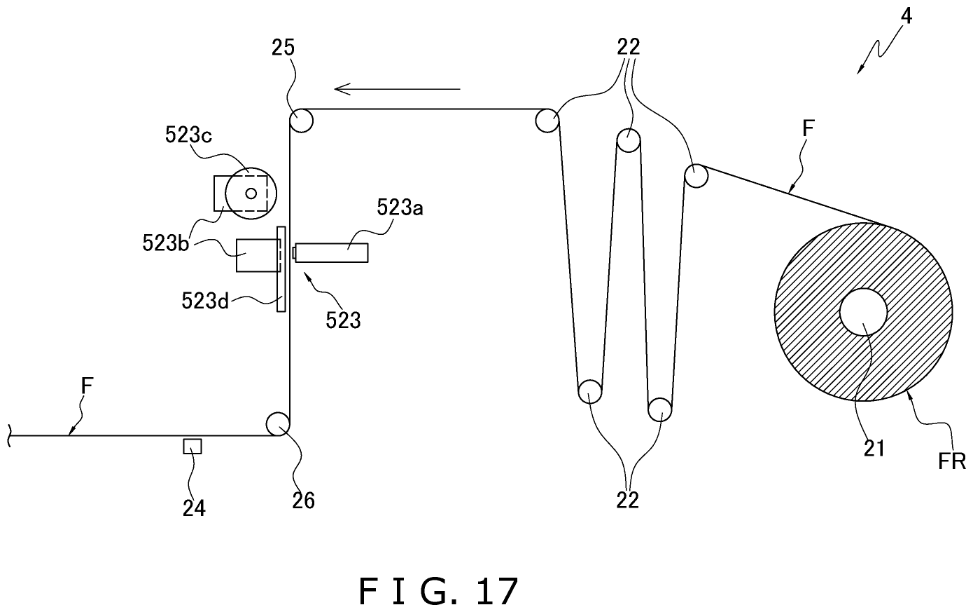

FIG. 16 is a simplified side view of the film supply unit 4 when the printing device 523 of the bag-making and packaging apparatus 1 according to the seventh embodiment is operating in the first printing mode. FIG. 17 is a simplified side view of the film supply unit 4 when the printing device 523 of the bag-making and packaging apparatus 1 according to the seventh embodiment is operating in the second printing mode.

### (1) Printing Device 523

The printing device 523 comprises mainly a print head 523a and a switching part 523b. The print head 523a prints predetermined printing information on the surface of the film F. The printing information is printed in a predetermined printing region on the surface of the film F.

When the package contents C are a food, for example, the printing information is a manufacturing date and an expiration date of the package contents C. The printing information is transmitted from the control unit to the printing device 423.

### (1-1) Print Head 523a

The print head 523a can move along the direction toward the film F or away from the film F during printing of the printing information.

### (1-2) Switching Part 523b

The switching part 523b illustrated in FIGS. 16 and 17 retains both a platen roller 523c and a platen plate 523d in advance. In the switching part 523b, a portion in which the platen roller 523c is retained and a portion in which the platen plate 523d is retained are not linked, and are independent from each other.

Therefore, the operator of the bag-making and packaging apparatus 1 can move the platen roller 523c and the platen plate 523d separately by moving only a portion of the switching part 523b.

In the plane of the paper surface of FIGS. 16 and 17, the portion in which the platen roller 523c is retained and the portion in which the platen plate 523d is retained can be moved independently of each other. Furthermore, the switching part 523b can cause the platen roller 523c and the platen plate 523d to move along the film F.

In the first printing mode in FIG. 16, the operator moves the platen roller 523c away from the print head 523a, and brings the platen plate 523d close to the print head 523a.

In the second printing mode in FIG. 17, the operator moves the platen plate 523d away from the print head 523a, and brings the platen roller 523c close to the print head 523a.

The operator can switch between the first printing state and the second printing state by moving the switching part 523b.

When switching the printing mode, the operator can also easily position the platens 523c, 523d in accordance with the printing mode without detaching the platens 523c, 523d from the film supply unit 4.

### Modifications

### (1) Modification A

In the first embodiment, the retaining part 23b retains either a platen roller 23c or a platen plate 23d. However, the retaining part 23b can retain both a platen roller 23c and a platen plate 23d.

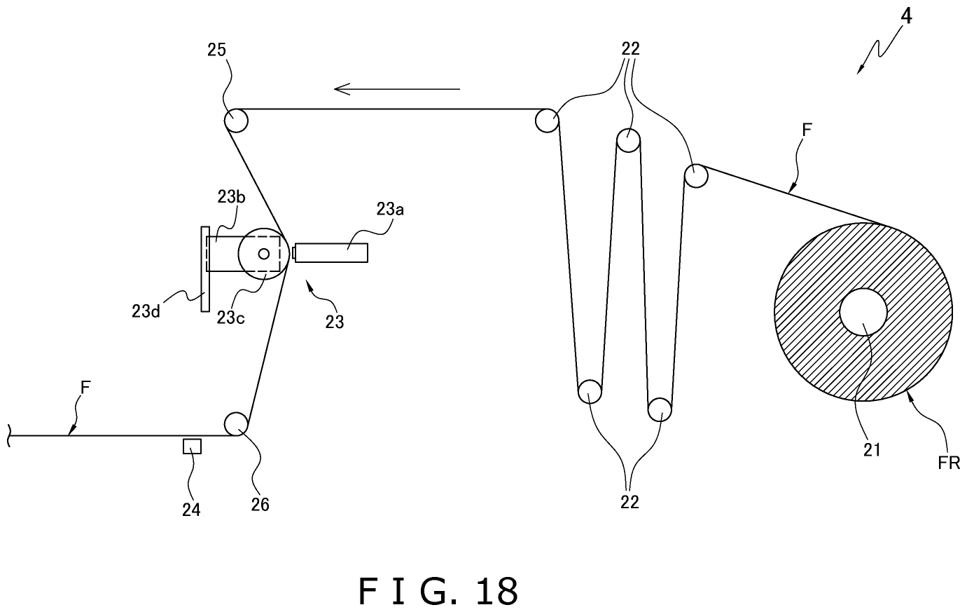

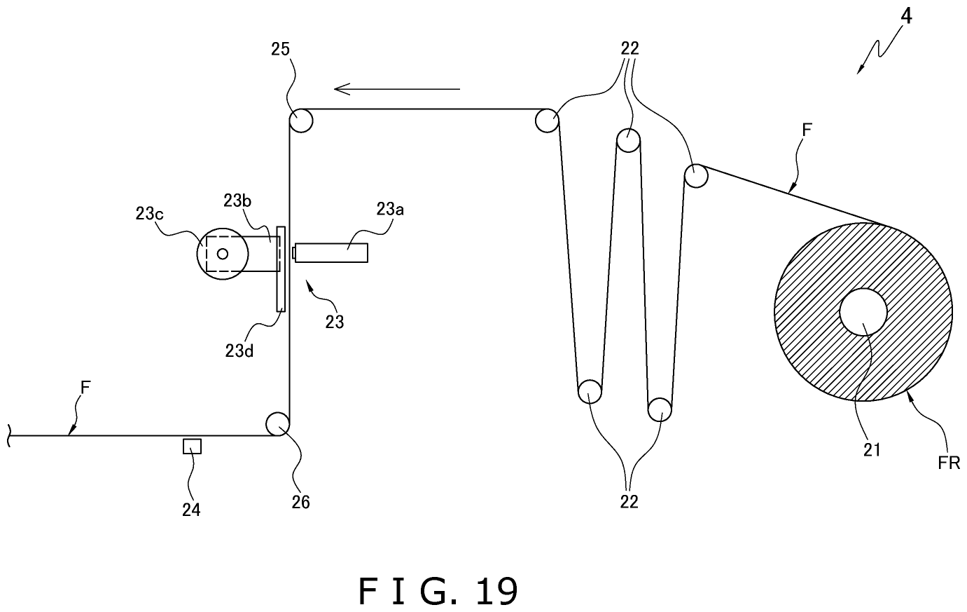

FIGS. 18 and 19 are side views showing a simplified configuration of the film supply unit 4 of the present modification, in the same manner as FIGS. 4 and 5. FIG. 18 illustrates a configuration in the continuous mode. FIG. 19 illustrates a configuration in the intermittent mode.

In the present modification, a platen roller 23c and a platen plate 23d are retained on respective end parts of the retaining part 23b. The retaining part 23b is configured so that the positions at which the platen roller 23c and the platen plate 23d are retained can be changed in accordance with the operating mode of the bag-making and packaging apparatus 1. In the continuous mode in FIG. 18, the platen roller 23c is retained in a position facing the print head 23a, and the platen plate 23d is retained in a position that is separated from the print head 23a. In the intermittent mode in FIG. 19, the platen plate 23d is retained in a position facing the print head 23a, and the platen roller 23c is retained in a position that is separated from the print head 23a. When switching the operating mode, the operator of the bag-making and packaging apparatus 1 removes the platen roller 23c and the platen plate 23d from the retaining part 23b. Before and after switching the operating mode, the operator attaches the platen roller 23c and the platen plate 23d to the retaining part 23b so that the positions in which the platen roller 23c and the platen plate 23d are retained are exchanged.

The retaining part 23b can be fixed to the film supply unit 4, and can be configured so as to be attachable to and detachable from the film supply unit 4. When the retaining part 23b is attachable to and detachable from the film supply unit 4, the operator of the bag-making and packaging apparatus 1 need only change the orientation of the retaining part 23b when switching the operating mode. In this case, the operator of the bag-making and packaging apparatus 1 can exchange the positions at which the platen roller 23c and the platen plate 23d are retained, without touching the platen roller 23c and the platen plate 23d.

### (2) Modification B

In the second embodiment, the switching part 123b is configured so that at least one of the platen roller 123c and the platen plate 123d are moved to switch between the first printing state and the second printing state. However, the switching part 123b can be configured so that the first printing state and the second printing state are switched by moving the print head 123a instead of by moving the platen roller 123c and the platen plate 123d. A specific example of the configuration of the switching part 123b will next be described.

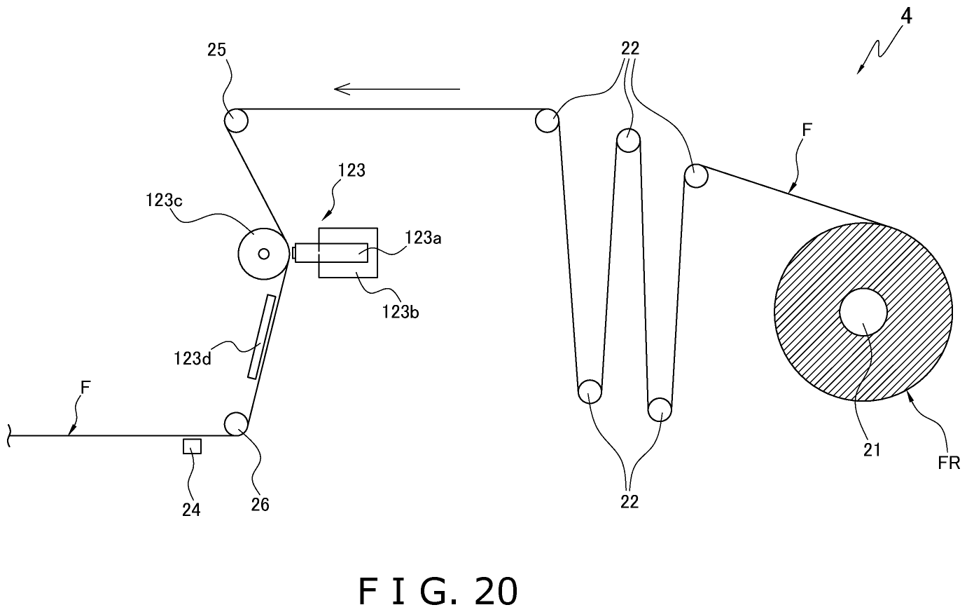

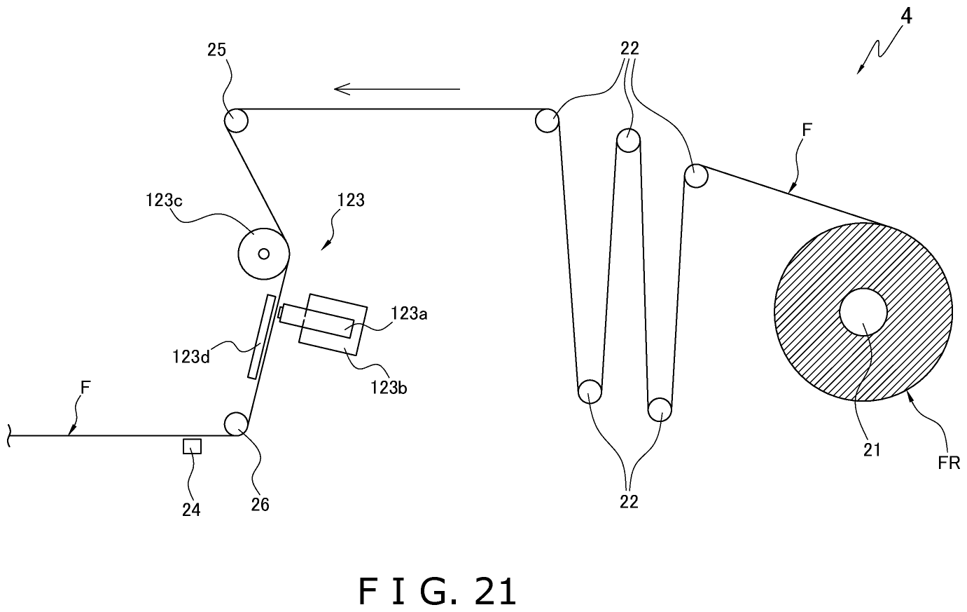

FIGS. 20 and 21 are side views showing a simplified configuration of the film supply unit 4 of the present modification, in the same manner as FIGS. 4 and 5. FIG. 20 illustrates a configuration in the continuous mode. FIG. 21 illustrates a configuration in the intermittent mode.

In the present modification, the switching part 123b is a member in which the print head 123a is retained, as illustrated in FIGS. 20 and 21. The positions of the platen roller 123c and the platen plate 123d are fixed. The switching part 123b is configured so as to be able to move between the position of the print head 123a in the first printing state illustrated in FIG. 20 and the position of the print head 123a in the second printing state illustrated in FIG. 21. The operator of the bag-making and packaging apparatus 1 can switch between the first printing state and the second printing state by moving the switching part 123b to cause the print head 123a to move along the film F.

### (3) Modification C

In the second embodiment, the switching part 123b is configured so that at least one of the platen roller 123c and the platen plate 123d are moved to switch between the first printing state and the second printing state. However, the switching part 123b can be configured so that the first printing state and the second printing state are switched by further moving the feed rollers 25, 26. During switching of the operating mode, the operator of the bag-making and packaging apparatus 1 can switch between the first printing state and the second printing state by operating the switching part 123b.

### (4) Modification D

In the second embodiment, during switching of the operating mode, the operator of the bag-making and packaging apparatus 1 can switch between the first printing state and the second printing state by manually moving the switching part 123b. However, the switching part 123b can also be configured so as to be movable by an air cylinder or other drive mechanism. In this case, the bag-making and packaging apparatus 1 can be configured so that it is possible to switch between the first printing state and the second printing state without manually moving the switching part 123b. Specifically, the bag-making and packaging apparatus 1 can be configured so that the operator can switch between the first printing state and the second printing state by operating the operation switch 5 or the liquid crystal display 6. In this case, the operation switch 5 can include a switch to switch the operating mode of the bag-making and packaging apparatus 1, and the liquid crystal display 6 can be a touch panel to display a screen image for switching the operating mode of the bag-making and packaging apparatus 1, for example.

### (5) Modification E

In the first through seventh embodiments, the bag-making and packaging apparatus 1 uses two types of platens, i.e., a platen roller 23c, 123c and a platen plate 23d, 123d. However, the present invention is also applicable to a bag-making and packaging apparatus 1 that uses three or more types of platens.

### REFERENCE SIGNS LIST

1 bag-making and packaging apparatus
7 control unit
8 instruction unit
10 bag-making and packaging apparatus
23a print head (printing part)
23b retaining part
23c platen roller (first receiving part)
23d platen plate (second receiving part)
25 first feed roller (conveyance roller)
123a print head (printing part)
123b switching part
123c platen roller (first receiving part)
123d platen plate (second receiving part)
123 printing device (printing part)
223 printing device (printing part)
323 printing device (printing part)
423 printing device (printing part)
523 printing device (printing part)
B bag
C package contents (article)
F film (packaging material)

What is claimed is:

1. A bag-making and packaging apparatus in which a bag containing a packaged article is formed from a packaging material in a state where the packaging material is conveyed, the bag-making and packaging apparatus comprising:
a printing part configured to print predetermined information on the packaging material before the bag is formed;
a first receiving part used in a first printing mode to print on the packaging material during conveyance thereof without stopping conveyance of the packaging material;
a second receiving part used in a second printing mode to print on the packaging material at a timing at which conveyance of the packaging material is stopped; and
a retaining part configured to retain at least one of the first receiving part or the second receiving part,
the retaining part further configured to retain at least one of the first receiving part or the second receiving part so that the first receiving part and the printing part face each other with the packaging material disposed therebetween in the first printing mode, and the second receiving part and the printing part face each other with the packaging material disposed therebetween in the second printing mode.

2. The bag-making and packaging apparatus according to claim 1, wherein
the first receiving part is a cylindrical member, and
the second receiving part is a flat-plate-shaped member.

3. The bag-making and packaging apparatus according to claim 1, further comprising:
a control unit configured to control operation of the printing part based on predetermined information inputted in advance,
the printing part having the first printing mode and the second printing mode as selectable printing modes for printing on the packaging material,
the control unit further configured to switch the printing mode to the first printing mode when the control unit determines that a timing of printing on the packaging material is during conveyance of the packaging material based on the predetermined information, and
the control unit further configured to switch the printing mode to the second printing mode when the control unit determines that the timing of printing on the packaging material is during stoppage of the packaging material based on the predetermined information.

4. The bag-making and packaging apparatus according to claim 1, further comprising:
a control unit configured to control operation of the printing part; and
an instruction unit,
the printing part having the first printing mode and the second printing mode as a plurality of selectable printing modes for printing on the packaging material,
the instruction unit configured to instruct the control unit to switch the printing mode,
the control unit further configured to instruct to switch the printing mode to the first printing mode when the control unit determines that the timing of printing on the packaging material is during conveyance of the packaging material based on predetermined information inputted in advance and an instruction from the instruction unit, and
the control unit further configured to instruct to switch the printing mode to the second printing mode when the control unit determines that the timing of printing on the packaging material is during stoppage of the packaging material based on predetermined information inputted in advance and an instruction from the instruction unit.

5. The bag-making and packaging apparatus according to claim 3, wherein
the control unit has, as selectable conveyance modes for conveying the packaging material, a first conveyance mode to continuously convey the packaging material and a second conveyance mode to intermittently convey the packaging material,
the predetermined information including a result of selecting the conveyance modes.

6. The bag-making and packaging apparatus according to claim 5, wherein
the control unit is further configured to switch the printing mode to the first printing mode when the conveyance mode is the second conveyance mode and the control unit determines that the timing of printing on the packaging material is during conveyance of the packaging material.

7. A bag-making and packaging apparatus in which a bag containing a packaged article is formed from a packaging material in a state where the packaging material is conveyed, the bag-making and packaging apparatus comprising:
a printing part configured to print predetermined information on the packaging material before the bag is formed;
a first receiving part configured to print on the packaging material during conveyance thereof without stopping conveyance of the packaging material;
a second receiving part configured to print on the packaging material at a timing at which conveyance of the packaging material is stopped; and
a switching part configured to switch between a first printing state in which the first receiving part and the printing part face each other with the packaging material disposed therebetween, and a second printing state in which the second receiving part and the printing part face each other with the packaging material disposed therebetween.

8. The bag-making and packaging apparatus according to claim 7, wherein
the switching part is further configured to switch between the first printing state and the second printing state by causing at least one of the first receiving part or the second receiving part to move.

9. The bag-making and packaging apparatus according to claim 7, wherein
the switching part is further configured to switch between the first printing state and the second printing state by causing the printing part to move.

10. The bag-making and packaging apparatus according to claim 9, wherein
the switching part is further configured to cause the printing part to move along the packaging material.

11. The bag-making and packaging apparatus according to claim 7, further comprising:
a conveyance roller configured to send the packaging material between the first receiving part and the printing part, or between the second receiving part and the printing part,
the switching part further configure to switch between the first printing state and the second printing state by causing the conveyance roller to move.

12. The bag-making and packaging apparatus according to claim 7, wherein
the first receiving part is a cylindrical member, and
the second receiving part is a flat-plate-shaped member.

13. The bag-making and packaging apparatus according to claim 7, further comprising:
a control unit configured to control operation of the printing part based on predetermined information inputted in advance,
the printing part having the first printing state and the second printing state as selectable printing modes for printing on the packaging material,
the control unit further configured to switch the printing mode to the first printing state when the control unit determines that a timing of printing on the packaging material is during conveyance of the packaging material based on the predetermined information, and
the control unit further configured to switch the printing mode to the second printing state when the control unit determines that the timing of printing on the packaging material is during stoppage of the packaging material based on the predetermined information.

14. The bag-making and packaging apparatus according to claim 7, further comprising:
a control unit configured to control operation of the printing part; and
an instruction unit,
the printing part having the first printing state and the second printing state as a plurality of selectable printing modes for printing on the packaging material,
the instruction unit configured to instruct the control unit to switch the printing mode,
the control unit further configured to instruct to switch the printing mode to the first printing state when the control unit determines that the timing of printing on the packaging material is during conveyance of the packaging material based on predetermined information inputted in advance and an instruction from the instruction unit, and
the control unit further configured to instruct to switch the printing mode to the second printing state when the control unit determines that the timing of printing on the packaging material is during stoppage of the packaging material based on predetermined information inputted in advance and an instruction from the instruction unit.

15. The bag-making and packaging apparatus according to claim 13, wherein
the control unit has, as selectable conveyance modes for conveying the packaging material, a first conveyance mode to continuously convey the packaging material and a second conveyance mode to intermittently convey the packaging material,
the predetermined information including a result of selecting the conveyance modes.

16. The bag-making and packaging apparatus according to claim 15, wherein
the control unit is further configured to switch the printing mode to the first printing state when the conveyance mode is the second conveyance mode and the control unit determines that the timing of printing on the packaging material is during conveyance of the packaging material.
